(19) United States
(12) Patent Application Publication
(10) Pub. No.: US 2011/0149292 A1
(43) Pub. Date: Jun. 23, 2011

(54) APPARATUS AND METHOD FOR ANALYZING OPTICAL CAVITY MODES

(75) Inventor: Michael Himmelhaus, Berlin (DE)

(73) Assignee: Fujirebio Inc., Tokyo (JP)

(21) Appl. No.: 12/737,902

(22) PCT Filed: Aug. 31, 2009
(86) PCT No.: PCT/JP2009/065545

§ 371 Date: Feb. 28, 2011

(30) Foreign Application Priority Data
Aug. 31, 2008 (EP) 08075740.4

(51) Int. Cl. G01J 3/45; G01B 9/02

(52) U.S. Cl. 356/454; 356/451

(57) ABSTRACT

A system for analyzing optical cavity modes of at least one microcavity or at least one cluster of microcavities, comprises, an apparatus for sensing a change in the condition of or for analyzing the optical cavity modes by utilizing an optical interference of the optical cavity modes.

### CROSS-REFERENCE TO RELATED APPLICATIONS

This application is a National Stage application of International Application No. PCT/JP2009/065545, filed on Aug. 31, 2009, which claims priority of European application number EP 08075740.4, filed on Aug. 31, 2008.

### BACKGROUND OF THE INVENTION

1. Field of the Invention

The present invention relates to a technology for analyzing optical cavity modes generated in an optical microcavity or optical microcavities.

The entire contents of an U.S. provisional application No. 60/796,162 filed on May 1, 2006, an U.S. provisional application No. 61/018,144 filed on Dec. 31, 2007, an U.S. provisional application No. 61/111,369 filed on Nov. 5, 2008, an U.S. provisional application No. 61/140,790 filed on Dec. 24, 2008 and an U.S. provisional application No. 61/218,260 filed on Jun. 18, 2009 are incorporated by reference.

2. Description of the Prior Art

Optical microcavities have been successfully applied to a variety of applications in optics, such as miniature laser sources (J. L. Jewell et al., Appl. Phys. Lett. Vol. 54, pp. 1400ff., 1989; M. Kuwata-Gonokami et al., Jpn. J. Appl. Phys. (Part 2) Vol. 31, pp. L99ff., 1992; S. M. Spillane et al., Nature (London) Vol. 415, pp. 621ff., 2002; V. N. Astratov et al., Appl. Phys. Lett. Vol. 85, pp. 5508ff., 2004), optical waveguides (V. N. Astratov et al., Appl. Phys. Lett. Vol. 85, pp. 5508ff., 2004), optical filters (L. Maleki et al., Proc. SPIE Vol 5435, pp. 178ff., 2004), and mechanical (M. Gerlach et al., Opt. Express Vol. 15, pp. 3597ff., 2007) or biological sensors (V. S. Ilchenko and L. Maleki, Proc. SPIE Vol. 4270, pp. 120ff., 2001; F. Vollmer et al., Appl. Phys. Lett. Vol. 80, pp. 4057ff., 2002). A number of recent reviews discuss fundamentals and the various applications of these systems in more detail (A. B. Matsko and V. S. Ilchenko, IEEE J. Sel. Top. Quantum Electron. Vol. 12, pp. 3ff., 2006; V. S. Ilchenko and A. B. Matsko, IEEE J. Sel. Top. Quantum Electron. Vol. 12, pp. 15ff., 2006; K. Vahala, Nature Vol. 424, pp. 839-846, 2003; A. N. Oraevsky, Quant. Electron. Vol. 32, pp. 377-400, 2002; F. Vollmer, S. Arnold, Nature Methods, Vol. 5, pp. 591-596, 2008).

The present invention proves useful and advantageous over existing technology in all cases that require precise characterization of cavity modes, for example in terms of their positions, bandwidths, and/or intensities, or minute changes thereof, while keeping the experimental efforts in terms of equipment applied and geometrical size of the set-up small. Examples of such art may be related to precision microlasers, optical filters, and to optical sensing in miniature devices. In the following, a summary of optical cavity mode sensors is given.

a) Work utilizing non-metallic microcavities with few micrometers of geometric cavity length: WO2005116615 describes tilt utilization of whispering gallery modes (WGMs) in spherical particles decorated with fluorescent semiconductor quantum dots for biosensing. Weller et al. (A. Weller et al., Appl. Phys. B, Vol. 90, pp. 561-567, 2008) report on biosensing by means of fluorescent polymer latex particles of few microns in diameter. Francois and Himmelhaus (A. Francois and M. Himmelhaus, Appl. Phys. Lett. Vol. 92, pp. 141107/1-3, 2008) utilized clusters of dye-doped polymer latex particles for biosensing. Woggon and coworkers (N. Le Thomas et al., J. Opt. Soc. Am. B, Vol. 23, pp. 2361-2365, 2006) demonstrated that the mode spectrum of non-fluorescent polymer latex particles can be exited in a range of some tens of nanometers by using a sharply focused broadband light source, such as a tungsten lamp or the output of an optical parametric oscillator, in combination with evanescent field coupling.

b) Work utilizing dielectric microcavities of several tens to several hundreds of micrometers of geometric cavity length: US2002/0097401A1, WO 02/13337A1, WO 02/01147A1, US 2003/0206693A1, US2005/022153A1, and WO 2004/038349A1.

Besides the non-metallic microcavities as used in the systems described above, also metal-coated or metal-decorated cavities can be utilized. WO 02/07113A1, WO 01/15288 A1, US 2004/0150818A1, and US 2003/0218744A1 describe the use of metal particles, metal particle aggregates, and semi-continuous metal films close to their percolation threshold, which may be optionally located in vicinity of a hollow microcavity, i.e. which may be optionally embedded inside of the microcavity. The metal particles/films may further bear a fluorescent material, such as a laser dye. WO2007129682 describes the use of fluorescent dielectric microcavities encapsulated into a metallic coating for biosensing applications.

For the analysis of optical cavities modes as described in the prior art above exclusively diffractive methods utilizing dispersive elements such as diffraction gratings or prisms have been applied. However, spectral analysis of light may alternatively be performed by utilization of interference effects, e.g. by means of a Fabry-Perot (FP) interferometer or etalon (FP interferometer with fixed mirror separation). Also other kinds of interferometers may be applied depending on the application. Examples of prior art are given in the following.

WO2007135244 reports a spectrometer based on FP interferometry, where the transmittance of the interferometer is spectrally sliced to at least two separate wavelength bands with an aim to detect at least two different orders of interference.

WO2007072428 claims a spectrophotometer based on a FP interferometer, in particular for the spectral analysis of a (light) source. US2006197958 reports about a integrated spectroscopy system involving multiple FP tunable filters.

U.S. Pat. No. 6,747,742 B1 describes an absorption spectrometer based on a Michelson interferometer that uses optionally either an FP interferometer or a microcavity for enhancement of light absorption by the analyte. This enhancement is based on the high number of roundtrips the radiation undergoes in the FP interferometer or the microcavity, respectively. The Michelson interferometer is used to analyze the radiation and thus to determine the absorption spectra as typically done in Fourier transform (infrared) spectrometers. It is not applied to characterize any cavity modes of the optional microcavity.

Liang et al. (Opt. Lett. Vol. 31, pp. 510-512, 2006) report about the transmission characteristics of a Fabry-Perot etalon coupled to a microtoroid. The resonance lineshapes depend strongly on the resonance wavelength detuning and coupling strength between the two resonators. Due to this coupling, the combined system exhibits novel optical properties, which require additional experimental efforts for their analysis. This is in contrast to the present invention, which utilizes an interferometer for the analysis of the optical properties of the microcavity or—cavities undistorted by the presence of the interferometer.

### SUMMARY OF THE INVENTION

The present invention has been achieved in order to solve the problems which may occur in the related arts mentioned above.

Optical cavity modes of microcavities have so far been characterized by means of two major schemes, depending on the kind of microcavity. As illustrated in FIG. 1(I), small cavities 1 with a relatively large free spectral range (FSR) of δλ>0.05 nm can be most conveniently analyzed by means of dispersive spectroscopy applying an optics for collection of the cavity emission 2, a dispersive element based on diffraction optics 5, such as a diffraction grating, for creation of a spatial-spectral relation, and a photodetector 7, such as a photomultiplier, photodiode, or charge-coupled device (CCD) camera for recording of the intensity of the dispersed light as a function of wavelength (more general “photon energy”). An aperture or slit 3 at the entrance of the dispersive monochromator 8 is needed to limit the geometrical size of the different colors at its exit to avoid cross-talk. This is achieved by imaging the entrance aperture or slit 3 by means of the optics 4 and 6 onto the exit focal plane of the monochromator 8. In this exit focal plane, either a second aperture or slit is placed, followed by a photodetector (not shown). Alternatively, as illustrated in FIG. 1, a CCD camera (exemplifying the photodetector 7) is mounted for parallel collection of a wide spectral range. If entrance aperture size and optics 4 and 6 are chosen properly, the optical resolution of the system is limited by the dispersion of the monochromator and by the pixel size of the CCD camera.

For example, the optical resolution of a monochromator with a focal length of f=550 mm equipped with a spectroscopic CCD camera (13.5 μm pixel size) and a high resolution grating (2400 Lines/mm holographic grating) is ideally Δλ=0.01 nm. However, some cross-talk between neighboring pixels on the CCD chip cannot be avoided, so that in practice the resolution is about 0.03 nm. In this calculation it was assumed that the resolution is solely determined by the pixel size of the CCD chip, i.e. that the entrance slit 3 is chosen sufficiently small (for data, cf. e.g., data sheet of Jobin Yvon, Triax 550). According to FIG. 1(I), the total optical path length inside of the monochromator 8 is 4×550 mm=2.2 m, if we assume f₁=f₂, which corresponds to a 1:1 magnification of the entrance slit at the monochromator exit. In case of f₁<f₂, the image of the entrance slit is magnified by the ratio f₂/f₁, which is unwanted because it affects the optical resolution. For f₁>f₂, the total optical path becomes even larger than for f₁=f₂. For same reason, neither object nor detector should be moved out of the focal planes of the respective lens systems 2 and 4.

For biosensing using fluorescent polymer latex beads (A. Weller et al., Appl. Phys. B, Vol. 90, pp. 561-567, 2008; A. Francois and M. Himmelhaus, Appl. Phys. Lett. Vol. 92, pp. 141107/1-3, 2008), the expected shifts in the mode positions upon adsorption of proteins are about Δλ_{WGM}=0.2-0.9 nm. To achieve sensing at sufficient resolution, the optical resolution of the detection system should be at least Δλ_{WGM}/8=0.025-0.11 nm. Accordingly, the optical path length of the monochromator will be typically in the range of 0.5-2.2 m. Obviously, such dimension is not best suited for the design of miniature sensing devices as they might be wanted, e.g., for point-of-care testing or other kinds of hand-held devices. Further, the total transmission through a dispersive monochromator scales inversely with its focal length, so that raising the optical resolution of the system decreases the transmitted light intensity and thus affects the detection limit of the system.

In contrast, larger microcavities with cavity lengths of typically up to several hundreds of micrometers may exhibit a FSR below the optical resolution a dispersive system may achieve with reasonable effort, i.e. at a reasonable geometrical size and optical transmission. Given the above example it becomes clear that for an optical resolution better than 0.03 nm, a dispersive monochromator becomes rather bulky. Therefore, in the literature a different read-out scheme has been applied here. As illustrated in FIG. 2, the microcavity is coupled via evanescent field coupling to the evanescent field of a prism, waveguide, or optical fiber. Light travelling in such coupling device can then tunnel through the air gap between coupler and microcavity if its frequency matches that of a cavity mode. The cavity mode excitation is then observable as a loss at the output side of the coupler and can be simply monitored by means of a photodetector. To allow single cavity mode tracking, the bandwidth of the excitation source applied must be smaller than the FSR of the microcavity and to have a clearly observable loss, it should be smaller—or at least of the same order—as the bandwidth of the selected cavity mode. This is typically achieved by means of a highly resolving tunable laser, such as a distributed feedback laser or a grating tunable laser diode. The laser line can then be tuned across the selected cavity mode for precise determination of the mode position.

This second scheme has a number of severe disadvantages. The need for evanescent field coupling means that two evanescent fields of the order of 100 nm have to be sufficiently well overlapped. Therefore, the distance between coupler and microcavity is typically in the range of few to few tens of nanometers, which is not only tedious to control, but also puts heavy demands on the mechanical stability of the system, in particular because any change in the distance will influence the cavity mode positions (P. Shashanka et al., Opt. Express Vol. 14, pp. 9460-9466, 2006). Further, a multiplexing device, for example as required for optical (bio-)sensing in array formats, is difficult to achieve, because each single cavity had to be coupled and read-out individually. Finally, the need for an optical coupler in immediate vicinity of the cavity jeopardizes any attempts of using such systems displaced or remotely, e.g. for in-situ sensing applications.

When considering possibilities for alternative detection schemes for the characterization of optical cavity modes, the inventor of the present invention surprisingly realized that the physical differences between interferometric and dispersive spectroscopy can be exploited for the development of detection systems that require fewer and less sophisticated parts and may become significantly smaller in geometrical size than those based on dispersive optics. Further, due to the high resolving power of multiple beam interference systems, such as the FP interferometer, also optical microcavities with extremely small FSR may become accessible to a spectral analysis of their light emission, thus resolving the need for tedious evanescent field coupling.

Further, interferometric systems can be designed such that losses are small, leading to an increase of the total transmission of the optical signal through the detection set-up, which will beneficently impinge on the sensitivity limit and overall precision of the measurement.

Therefore, as will be elucidated in detail below, interference spectroscopy will contribute to a significant evolution of the utilization of microcavities in different size regimes and for a variety of applications, such as the development of precision microlasers, optical filters, and optical sensors.

With regard to optical sensing, robust and easy-to-use portable or hand-held systems of high sensitivity, as they are needed for fast testing and screening in agriculture, food industry, environmental testing, civil security, and health care, will be drastically facilitated due to such novelty. In health care, for example, the increasing need for cost reduction drives the demand on point-of-care testing and self tests, which require simple, hand-held label-free biosensors that should be also capable of detection of a number of different analytes simultaneously (multiplexing).

### BRIEF DESCRIPTION OF THE DRAWINGS

FIG. 1 FIG. 1 is a schematic view that depicts basic set-ups for analysis of optical cavity modes, wherein FIG. 1(I) shows a scheme utilizing a collection optics and an optional aperture to increase the collected light intensity, and FIG. 1(II) shows a scheme processing the light emission of the microcavity directly;

FIG. 2 is a schematic view that depicts schemes of evanescent field coupling, wherein FIG. 2(1) shows a microcavity coupled to an optical fiber, FIG. 2(2) shows a microcavity coupled to a prism, and FIG. 2(3) shows a microcavity coupled to a focused laser beam;

FIG. 3 is a schematic view that depicts the principle of Fabry-Perot Interferometry;

FIG. 4 shows graphs of the optical cavity mode spectrum of a 10 μm Coumarin 6G-doped polystyrene bead, wherein the upper graph shows the spectra of the bead in air, and the lower graph shows the spectra of the bead immersed in water (PBS buffer);

FIG. 5 shows graphs, wherein the upper graph shows an autocorrelation function, i.e. modulation of the FP interferometric spectrometer output, when shifting a transmitted cavity mode to longer wavelengths, and the lower graph shows the spectral comb structure (peaks refer to transmission maxima) of a FP interferometer with a FSR of the order of the bandwidth of an optical cavity mode to be analyzed (dotted line);

FIG. 6 is a schematic view that depicts an optical set-up for the recording of interference patterns induced by the radiative emission of a microcavity; and

FIG. 7 shows interference patterns and corresponding cavity mode emission spectra of a microcavity, wherein the focus of the excitation laser is either positioned such that it does not hit the microcavity (left column) or that it hits the microcavity resulting in fluorescence emission from the latter (right column).

### DETAILED DESCRIPTION OF THE PREFERRED EMBODIMENTS

4.1 Definition of Terms

C6G: Coumarin 6 laser grade

CCD: Charge-coupled device

DFB laser: Distributed feedback laser

FP: Fabry-Perot

FPM: Fabry-Perot mode

FSR: Free spectral range

N. A.: Numerical aperture

PBS: Phosphate Buffered Saline

PDMS: Poly(dimethylsiloxane)

PE: Polyelectrolyte

PAH: Poly(allylamine)hydrochloride

PSS: Poly(sodium 4-styrenesulfonate)

PS: Polystyrene

TE: Transverse Electric optical mode

TM: Transverse Magnetic optical mode

WGM: Whispering gallery mode

Reflection and Transmission at a Surface:

In general, the surface of a material has the ability to reflect a fraction of impinging light back into its ambient, while another fraction is transmitted into the material, where it may be absorbed in the course of its travel. In the following we call the power ratio of reflected light to incident light the “Reflectivity” or “Reflectance”, R, of the ambient/material interface (or material/ambient interface). Accordingly, the power ratio of transmitted light to incident light is called the “Transmittance”, T, of this interface. Note, that R and T both are properties of the interface, i.e. their values depend on the optical properties of both, the material and its ambient. Further, they depend on the angle of incidence and the polarization of the light impinging onto this interface. Both R and T can be calculated by means of the Fresnel equations for reflection and transmission. The same terminology can be also applied to the total reflection and total transmission of a stratified sequence of interfaces, such as effective for example in a thin film interferometer.

Optical Cavity:

An optical cavity is a closed volume confined by a closed boundary area (the “surface” of the cavity), which is highly reflective to light in the ultraviolet (UV), visible (vis) and/or infrared (IR) region of the electromagnetic spectrum. Besides its wavelength dependence, the reflectance of this boundary area may also be dependent on the incidence angle of the light impinging on the boundary area with respect to the local surface normal. Further, the reflectance may depend on the location, i.e. where the light impinges onto the boundary area. The inner volume of the optical cavity may consist of vacuum, air, or any material that shows high transmission in the UV, visible, and/or IR. In particular, transmission should be high at least for a part of those regions of the electromagnetic spectrum, for which the surface of the cavity shows high reflectance. An optical cavity may be coated with a material different from the material of which the optical cavity is made. The material used for coating may have, e.g., different optical properties, such as different refractive index or absorption coefficient. Further it may comprise different physical, chemical, or biochemical properties than the core material of the optical cavity, such as different mechanical strength, chemical inertness or reactivity, and/or antifouling or related biofunctional functionality. In the following, this optional coating is referred to as “shell”, while the optical cavity is called “core”. Further, the total system, i.e. core and shell together, are referred to as “(optical) microresonator”. The latter term is also used to describe the total system in the case that no shell material is applied. In addition to the shell discussed here, a part of the surface of the microresonator may be coated with additional layers (e.g. on top of the shell) as part of the sensing process, for example to provide a suitable biofunctional interface for detection of specific binding events or in the course of the sensing process when target molecules adsorb on the microresonator surface or a part of it.

An optical cavity (microresonator) is characterized by two parameters: First, its free spectral range δλₘ, and second, its quality factor Q. In the following, the term “optical cavity” (microresonator) refers to those optical cavities (microresonators) with a quality factor Q>1. Depending on the shell material used, the light stored in the microresonator may be stored in the optical cavity solely, e.g. when using a highly reflective metal shell, or it may also penetrate into the shell, e.g. when using a dielectric or semiconducting shell. Therefore, it depends on the particular system under consideration, which terms (FSR and Q-factor of the optical cavity or those of the microresonator) are more suitable to characterize the resulting optical properties of the microresonator.

Free Spectral Range (FSR):

The free spectral range δλ of an optical system refers to the spacing between its optical modes. For an optical cavity, the FSR is defined as the mode spacing, δλₘ=λₘ−λₘ₊₁, where m is the mode number and λₘ>λₘ₊₁. Analogously, for an interferometer, it is the spacing between neighboring orders of intensity maxima (or minima, respectively).

Quality Factor:

The quality factor (or “Q-factor”) of an optical cavity is a measure of its potential to trap photons inside of the cavity. It is defined as

$$Q = \frac{ stored energy }{loss per roundtrip} = \frac{{ω}_{m}}{{Δω}_{m}} = \frac{{λ}_{m}}{Δ {λ}_{m}} \qquad ( 1 )$$

where ωₘ and λₘ are frequency and (vacuum) wavelength of cavity mode with mode number m, respectively, and Δωₘ and Δλₘ are the corresponding bandwidths. The latter two equations connect the Q-factor with position and bandwidth of the optical modes inside of the cavity. Obviously, the storage potential of a cavity depends on the reflectance of its surface. Accordingly, the Q-factor may be dependent on the characteristics of the cavity modes, such as their wavelength, polarization, and direction of propagation.

Volume of an Optical Cavity:

The volume of an optical cavity is defined as its inner geometrical volume, which is confined by the surface of the cavity, i.e. the highly reflective boundary area.

Ambient (Environment) of an Optical Cavity or Microresonator:

The “ambient” or “environment” of an optical cavity or microresonator is that volume enclosing the cavity (microresonator), which is neither part of the optical cavity, nor of its optional shell (in the case of a microresonator). In particular, the highly reflective surface of the optical cavity (or microresonator) is not part of its ambient. It must be noted that in practice, the highly reflective surface of the optical cavity (microresonator) has a finite thickness, which is not part of the ambient. The same holds for the optional shell, which has also a finite thickness and does not belong to the microresonator's ambient. The ambient or environment of an optical cavity (microresonator) may comprise entirely different physical and chemical properties from that of the cavity (microresonator), in particular different optical, mechanical, electrical, and (bio-) chemical properties. For example, it may strongly absorb in the electromagnetic region, in which the optical cavity (microresonator) is operated. The ambient may be heterogeneous. The extension to which the enclosing volume is considered as ambient, depends on the application. In the case of a microresonator brought into a microfluidic device, it may be the microfluidic channel. Typically, the ambient it is that part of the enclosing volume of the optical cavity or microresonator, which is of relevance for the optical cavity's (microresonator's) operation, for example in terms of its impact on the optical cavity modes of the cavity (microresonator) in view of their properties, excitation, and/or detection.

Optical Cavity Mode:

An optical cavity mode or just “cavity mode” is a wave solution of the electromagnetic field equations (Maxwell equations) for a given cavity. Different modes may have different directions of propagation depending on geometry and optical properties of the cavity. These modes are discrete and can be numbered with an integer m, the so-called “mode number”, due to the restrictive boundary conditions at the cavity surface. Accordingly, the electromagnetic spectrum in presence of the cavity can be divided into allowed and forbidden zones. The complete solution of the Maxwell equations consists of internal and external electromagnetic fields inside and outside of the cavity, respectively. In the following, the term “cavity mode” refers to the inner electromagnetic fields inside the cavity (within the cavity volume as defined above) unless otherwise stated. The wave solutions depend on the shape and volume of the cavity as well as on the reflectance of the boundary area, i.e. the cavity surface.

The full set of solutions of Maxwell's equations comprises also the fields outside of the optical cavity (microresonator), i.e. in the cavity's (microresonator's) ambient. Here, two kinds of solutions must be distinguished: those where the solutions describe freely propagating waves in the ambient and those where the solutions describe evanescent fields. The latter come into existence for waves, for which propagation in the ambient is forbidden, e.g. due to total internal reflection at the surface of the optical cavity (microresonator). One example for optical cavity modes that comprise evanescent fields in the ambient are WGMs. Another example is related to microresonators with a metal coating as shell. In these cases, surface plasmons may be excited at the metal/ambient interface, which also may exhibit an evanescent field extending into the ambient. In all these cases the evanescent field extents typically for a distance roughly of the order of the wavelength of the light generating the evanescent field into the ambient.

It should be noted that in practice, also evanescent fields may show some leakage, i.e. propagation of photons out of the evanescent field into the far field of the optical cavity, i.e. far beyond the extension of the evanescent field into the ambient. Such waves are caused, for example, by scattering of photons at imperfections or other kinds of causes, which are typically not accounted for in the theoretical description, since the latter typically assumes smooth interfaces and boundary layers. Such stray light effects are not considered in the following, i.e. do not hamper the evanescent field character of an ideally evanescent field. In the same way, evanescent field tunneling across a nanometer-sized gap into a medium, in which wave propagation is then allowed, does not hamper the evanescent field character of the evanescent field.

For spherical cavities, there exist two main types of solutions, for which the wavelength dependence can be easily estimated, one for light propagation in radial direction and one for light propagation along the circumference of the sphere, respectively. In the following, we will call the modes in radial direction “Fabry-Perot Modes” (FPM) due to analogy with Fabry-Perot interferometers. The modes forming along the circumference of the spheres are called “Whispering Gallery Modes” (WGM) in analogy to an acoustic phenomenon discovered by Lord Rayleigh. For a simple mathematical description of the wavelength dependence of these modes, we use the standing wave boundary conditions in the following:

$${λ}_{m} = \frac{4 {Rn}_{cav}}{m} , m = 1 , 2 , 3 , \qquad ( 2 )$$

for FPM, which states that the electric field at the inner particle surface as to vanish for all times, as is the case e.g. for a cavity with a metallic coating. For WGM, the boundary conditions yield

$${λ}_{m} = \frac{2 π {Rn}_{cav}}{m} \qquad ( 3 )$$

which basically states that the wave has to return in phase after a full roundtrip. In both formulas, “m” is an integer and is also used for numbering of the modes, i.e., as their mode number, R is the sphere radius, and n_{cav} the refractive index inside of the cavity. For sake of brevity, in the following the term “cavity mode m” will be used synonymously with the term “cavity mode with mode number m”.

From equations (2) and (3), the FSR δλₘ of FPM and WGM, respectively, of spherical cavities can be calculated to

$${δλ}_{m} = \frac{{λ}_{m}}{m + 1} = \frac{{λ}_{m + 1}}{m} \qquad ( 4 )$$

Direct Interference of Optical Cavity Modes:

Optical cavity modes may be spatially and temporally overlapped in the ambient either in the near field or in the far field. Such superposition may cause interference between the modes, if proper conditions are met, e.g. in terms of their polarization, direction of propagation, and/or their coherence. Such proper conditions may be supported, e.g., by reflection of one or more of the superposed cavity modes at an interface to alter their direction or polarization. In all these cases, in which no additional interferometric element, such as an interferometer as defined below, is applied, the interference is called “direct interference of optical cavity modes” in the following.

Optical Microcavity:

In the following, an optical cavity or microresonator is called an “optical microcavity”, if the optical cavity or microresonator exhibits an evanescent field extending into its ambient under the respective mode of operation. In the same sense, a cluster of optical cavities or microresonators is called a “cluster of optical microcavities”, if at least one of the optical cavities or microresonators constituting the cluster exhibits an evanescent field extending into its ambient under the respective mode of operation.

Alternatively, an optical cavity or microresonator is called an “optical microcavity”, if one or more optical cavity modes show direct interference under the respective mode of operation. In the same sense, a cluster of optical cavities or microresonators is called a “cluster of optical microcavities”, if one or more of the optical cavity modes of at least one of the optical cavities or microresonators constituting the cluster exhibits direct interference under the respective mode of operation.

Further, one or more microcavities or clusters of microcavities may be part of a larger optical system comprising other kinds of optical elements than microcavities or clusters of microcavities as defined above. Also such complex systems will be called microcavity or cluster of microcavities in the following.

Mode Coupling:

We define mode coupling as the interaction between cavity modes emitted by two or more microresonators that are positioned in contact with each other or in close vicinity to allow an optical contact. This phenomenon has been pointed out by S. Deng et al. (Opt. Express Vol. 12, pp. 6468-6480, 2004) who have performed simulations on mode guiding through a series of microspheres. The same phenomenon has been experimentally demonstrated by V. N. Astratov et al. (Appl. Phys. Lett. 83, pp. 5508-5510, 2004), who used a chain of non-fluorescent microspheres as waveguide and a single fluorescent microsphere positioned at one end of the microsphere waveguide in order to couple light into the chain. They have shown that the cavity modes produced by the fluorescent microsphere under excitation can propagate along the non-fluorescent microsphere chain, which means that light can be coupled from one sphere to another. The authors relate this coupling from one microsphere to another to “the formation of strongly coupled molecular modes or crystal band structures”.

T. Mukaiyama et al. (Phys. Rev. Lett. 82, pp. 4623-4626, 1999) have studied cavity mode coupling between two microspheres as a function of the radius mismatch between the microspheres. They have found that the resulting cavity mode spectrum of the bi-sphere system is highly depending on the radius mismatch of the two microspheres. More recently, P. Shashanka et al. (Opt. Express Vol. 14, pp. 9460-9466, 2006) have shown that optical coupling of cavity modes generated in two microspheres can occur despite of a large radius mismatch (8 and 5 μm). They have shown that the coupling efficiency depends strongly on the spacing between the two microspheres and as a result, the positions of the resonant wavelengths also depend on the microsphere spacing.

Optical Contact:

Two microresonators are said to have an “optical contact”, if light can transmit from one resonator to the other one and vice versa. In this sense, an optical contact allows potentially for mode coupling between two resonators in the sense defined above. Accordingly, a microresonator has an optical contact with the substrate if it may exchange light with it.

Clusters:

A cluster is defined as an aggregate of cavities (microresonators), which may be either in 2 or 3 dimensions. The individual cavities (microresonators) are either positioned in such a way that each cavity is individually coated or in such a way that neighboring cavities within a cluster form optical contacts with each other. The clusters may be formed randomly or in an ordered fashion for example using micromanipulation techniques and/or micropatterning and/or self-assembly. Further, the clusters may be formed in the course of a sensing process, for example inside of a medium, such as a live cell, after penetration of cavities (microresonators) into the medium to facilitate sensing of the wanted physical, chemical, biochemical, and/or biomechanical property. In general, the clusters of particles can be distributed over the surface in a random or an ordered fashion which may be either in two- or in three-dimensional structures. Thereby, photonic crystals may be formed.

Lasing Threshold:

The threshold for stimulated emission of a microresonator (optical cavity), also called the “lasing threshold”, is defined as the optical pump power of the microresonator where the light amplification via stimulated emission just compensates the losses occurring during propagation of the corresponding light ray within the microresonator. Since the losses for light rays traveling within a cavity mode are lower than for light rays that do not match a cavity mode, the cavity modes exhibit typically the lowest lasing thresholds (which may still differ from each other depending on the actual losses of the respective modes) of all potential optical excitations of a microresonator. In practice, the lasing threshold can be determined by monitoring the optical output power of the microresonator (e.g. for a specific optical cavity mode) as a function of the optical pump power used to stimulate the fluorescent material of the microresonator (also called the “active medium” in laser physics). Typically, the slope of this dependence is (significantly) higher above than below the lasing threshold so that the lasing threshold can be determined from the intersection of these two dependencies. When talking about the “lasing threshold of an optical microresonator”, one typically refers to the lasing threshold of that optical cavity mode with the lowest threshold within the observed spectral range. Analogously, the lasing threshold of a cluster of microresonators addresses the lasing threshold of that optical cavity mode within the cluster with the lowest threshold under the given conditions.

Interferometry:

Interferometry is the technique of using the pattern of interference created by the superposition of two or more waves to diagnose the properties of the aforementioned waves. The instrument used to interfere the waves together is called an “interferometer”. In the plane of observation, an interferometer produces a pattern of varying intensity, which originates from the interference of the superposed waves. Typically, the pattern exhibits circular symmetry and consists of a center spot surrounded by bright (and dark) rings. In the following, it will be therefore referred to as “fringe pattern”. The center spot will be called “central fringe”.

Fabry-Perot Interferometer:

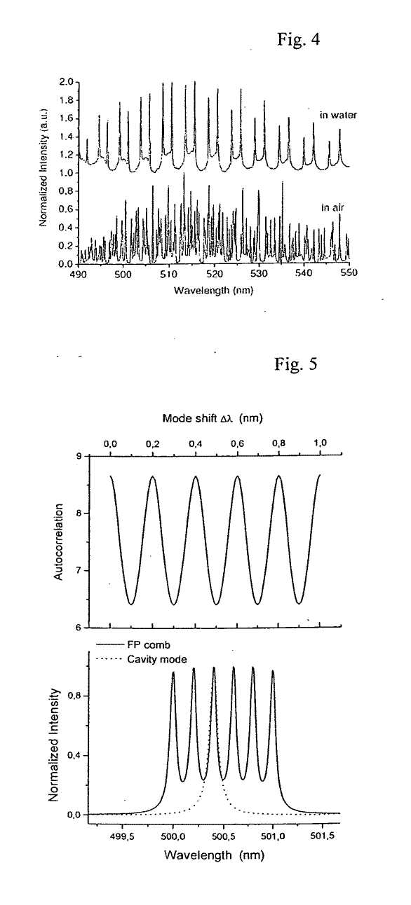

Interferometer utilizing the multiple beam interference between two parallel plates, separated by distance d. The volume between the plates may be filled with a dielectric medium of refractive index n_{f}. The optical distance is then given by d_{f}=n_{f} d. FIG. 3 illustrates the basic principle. The interference pattern observable on the screen is governed by the Airy function

$$A = \frac{{I}_{t}}{{I}_{i}} = \frac{1}{1 + G {sin}^{2} ( δ / 2 )}$$

(for loss-free system), where Iₜ and Iᵢ are transmitted and incident intensities, respectively,

$$\frac{δ}{2} = \frac{2 π}{{λ}_{0}} {d}_{f} cos {θ}_{t}$$

is the phase shift between two consecutive reflections, and

$$G = \frac{4 R}{{( 1 - R )}^{2}}$$

is the so-called “coefficient of finesse”. □₀ represents the vacuum wavelength of the incoming light and □t the angle of light propagation inside of the interferometer with respect to the normal of the plates (see FIG. 3). The FSR between neighboring maxima is

$${δλ}_{FP} \approx \frac{{λ}_{0}^{2}}{2 {d}_{f}}$$

and the bandwidth of the individual maxima amounts to

$${Δλ}_{FP} = \frac{{λ}_{0}^{2}}{π {d}_{f} cos {θ}_{t} \sqrt{G}}$$

(full width-half maximum). For the central fringe with cos □ₜ=1, this gives

$${Δλ}_{FP}^{min} = \frac{{λ}_{0}^{2}}{π {d}_{f} \sqrt{G}} .$$

This latter expression is also known as the chromatic resolving power of the FP interferometer and is linked to its FSR by

$$F = \frac{{δλ}_{FP}}{{Δλ}_{FP}^{min}} ,$$

where

$$F = \frac{π}{2} \sqrt{G}$$

is the so-called “finesse” of the FP interferometer. For an ideal, i.e. loss-free, FP interferometer, the finesse is solely given by the reflectance R of its plates,

$$R = \frac{π \sqrt{R}}{1 - R} .$$

For a wavelength λ_{0,m}_{ₘₐₓ}, for which the center fringe of the interference pattern is an intensity maximum, the maximum with highest interference order mₘₐₓ, which refers to the center fringe (see FIG. 3), can be calculated from

$${m}_{max} = \frac{2 {d}_{f}}{{λ}_{0 , {m}_{max}}} - \frac{1}{2} .$$

The highest order minimum surrounding the center fringe can then be found by

$$cos {θ}_{t , {m}_{max}} = ( 1 - \frac{{λ}_{0 , {m}_{max}}}{4 {d}_{f}} ) .$$

By applying Snell's law, the angle measured from the plates' normal, under which this minimum can be observed on the screen (see FIG. 3), is given by

$$sin {θ}_{e , {m}_{max}}^{min} = \frac{{n}_{f}}{{n}_{i}} \frac{{λ}_{0 , {m}_{max}}}{4 {d}_{f}} \sqrt{\frac{8 {d}_{f}}{{λ}_{0 , {m}_{max}}} - 1} \qquad ( 5 )$$

A derivation of these formulas can be found, e.g., in E. Hecht, A. Zajac, Optics, Addison-Wesley Publishing Company, Reading, Mass., 4^{th} printing 1979.

Analysis of Optical Cavity Modes:

According to the definitions above, optical cavity modes provide information about the optical cavity (cavities), in which they are generated, with respect to the cavity's (cavities') geometry (as expressed, e.g., by the FSR, the mode spacing and mode occurrence in general (polarization, direction and kind of propagation, etc.)), optical trapping potential for a certain wavelength and/or polarization (as expressed e.g. by the respective Q-factors), and the cavity's (cavities') physical condition and/or interaction with its (their) environment (as expressed e.g. by appearance, disappearance, increase or decrease in field strength or intensity, polarization, broadening, shifting, and/or splitting of cavity modes).

All this information may be revealed by analysis of optical cavity modes with respect to the measurement of mode positions, mode spacings, mode occurrence, field strengths, intensities, bandwidths, Q-factors, polarization, direction and kind of propagation, and/or changes thereof. The term “analysis of optical cavity modes”, which will be used for the sake of brevity in the following, comprises all kinds of measurements, which allow the determination of one or more of these mode properties or changes thereof.

The present invention proves useful and advantageous over existing technology in all cases that require precise characterization of cavity modes, for example in terms of their positions, bandwidths, and/or intensities, or minute changes thereof. In the following a number of fundamental embodiments is explained in all relevant technical details. From these examples general procedures for successful application of interference spectroscopy will become clear and thus allow those skilled in the art to transfer these results also to the analysis of microcavities not discussed here in detail. For example, we will limit ourselves to spherical microcavities mainly for two reasons. First of all spherical microcavities are the ones most studied in the literature so far and second, their mathematical treatment is well known. However, any other kind of microcavity that is able to host cavity modes with a FSR larger than their respective bandwidths, such as toroids (D. K. Armani et al., Nature Vol. 421, pp. 925ff., 2003), pillars (H. J. Moon et al., Opt. Commun. Vol. 235, pp. 401ff., 2004), or micro- or nanocrystals with plain reflecting surfaces (T. Nobis et al., Phys. Rev. Lett. Vol. 93, pp. 103903/1ff., 2004), can be analyzed in the same or analogous way. For the same reasons, we will discuss the interferometric spectrometer with the FP interferometer as an example. The latter one is obviously useful for our purpose of building a simple and miniature analysis system due to its small dimension and high resolving power. Further, as given above, the mathematical description of all relevant optical properties is readily available. Nevertheless, as will be discussed along with other parts and required materials in the materials section, any other kind of interferometer, which provides the wanted optical properties, such as proper FSR and resolving power, can be utilized in an analogous fashion. The same holds for all other materials described in the following, which have been selected to match and describe real systems as found in the literature. Other kinds of materials that may be applied in the future will be described in more detail in the materials section.

It should be further noted that the interferometric detection principles described in the following are not intended to be optically coupled to the microcavity or microcavities to form a coupled system with resultant changes in the optical cavity modes of the microcavity or microcavities as suggested, e.g., by Liang et al. (Opt. Lett. Vol. 31, pp. 510-512, 2006). The particular advantage of utilization of microcavities for various applications, such as optical sensing, e.g. in a microfluidic environment, is related to their small size and thus the high localization of their function. In the case of optical coupling and the establishment of optically coupled states, this localization is jeopardized because in a coupled system of microcavity/microcavities and interferometer used for their analysis, also the condition of the interferometer contributes to the condition of the physical states, i.e. optical modes of the combined system. In most cases, this is unwanted because the result of the sensing process will be influenced by the condition of the interferometer in such case. Therefore, in preferred embodiments, the interferometer used for analysis of cavity modes is not optically coupled but an independent device used solely for the analysis of optical cavity modes of the (by the interferometer) unperturbed microcavity/microcavities (or clusters thereof). In this sense, a coupled interferometer/optical cavity system must be considered as an a priori unkown device, which may be analyzed and characterized by means of a non-coupled interferometric element as described in the present embodiment. In generalization of this view, the optical microcavities and/or clusters of optical microcavities discussed in the following can be considered as optical systems containing one or more optical microcavities in addition to other, basically arbitrary optical elements. The entire system(s) can then be analyzed and characterized as a whole by the interferometric detection principles described in the following.

4.2.1 Analysis of Cavity Modes by Means of an Interferometer with a Free Spectral Range of the Order of the Bandwidths of the Optical Cavity Modes to be Studied

The first example will describe an interferometric spectrometer for analysis of optical cavity modes that utilizes an interferometer with a FSR δλ of the order of the bandwidth of the cavity modes. As given above, the bandwidths of the cavity modes, Δλₘ, depend linearly on the mode position, λₘ, and inversely proportional on the quality factor Q of the microcavity. From the literature it is known that the Q-factor drops drastically with the size of the cavity. For silica spheres in the size range of several tens to some hundreds of micrometers it can yield very high values, even in liquid environment. Vollmer et al., for example, report Q=2×10⁶ for 300 μm silica spheres in aqueous environment (S. Arnold et al., Optics Lett. Vol. 28, pp. 272-274, 2003). Smaller particles of few micrometers in size and below, exhibit much lower Q-factors from few thousands down to some tens (A. Weller et al., Appl. Phys. B, Vol. 90, pp. 561-567, 2008). Accordingly they show much broader bandwidths of their cavity modes.

In the following, we will first describe a device capable of tracing changes in the mode positions of low-Q particles with rather broad bandwidths, such as polymer latex beads of few micrometers in diameter. To work out a realistic example, we have chosen the recent work of Francois & Himmelhaus (Appl. Phys. Lett. Vol. 92, pp. 141107/1-3, 2008), who utilized C6G-doped PS latex beads with a nominal diameter of 10 μm. As discussed in that article, not only individual beads, but also clusters of beads can be utilized for optical sensing. For 10 μm beads the authors found a spectral shift of Δλ_{PE}=0.2 nm for one bilayer of PE. The bandwidths of the first order modes in an aqueous environment (PBS) was determined to about Δλₘ=0.1 nm. As reported by the same authors (A. Francois et al., Proc. SPIE Intl. Soc. Opt. Eng., Vol. 6862, pp. 68620Q/1-8, 2008), the complex cavity mode spectrum of C6G-doped PS beads reduces to 1^{st} order excitations with a FSR of about 5 nm, when the beads are brought into water. This is illustrated in FIG. 4, which is taken from the literature. According to FIG. 4, in aqueous environment, the spectra consist of a sequence of doublets, which arise from TE and TM mode excitations. The spacing between peaks within the doublets is about 2 nm. Excitation of the cavity modes in this example is achieved by focusing the 442 nm line of a HeCd laser onto single particles or clusters of particles, which are adsorbed on a glass cover slip and protected by a microfluidic cover made from PDMS.

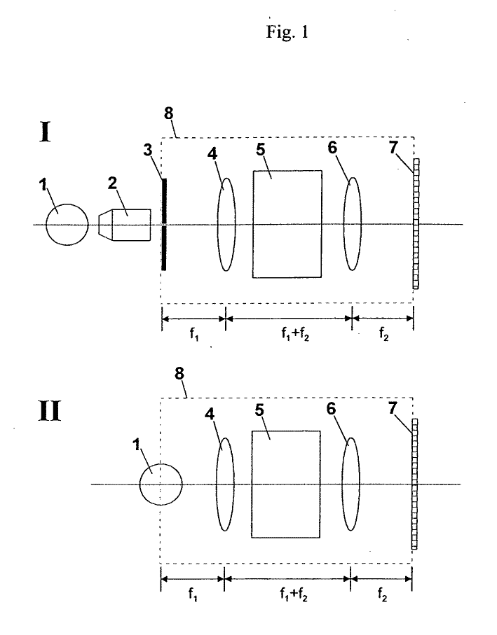

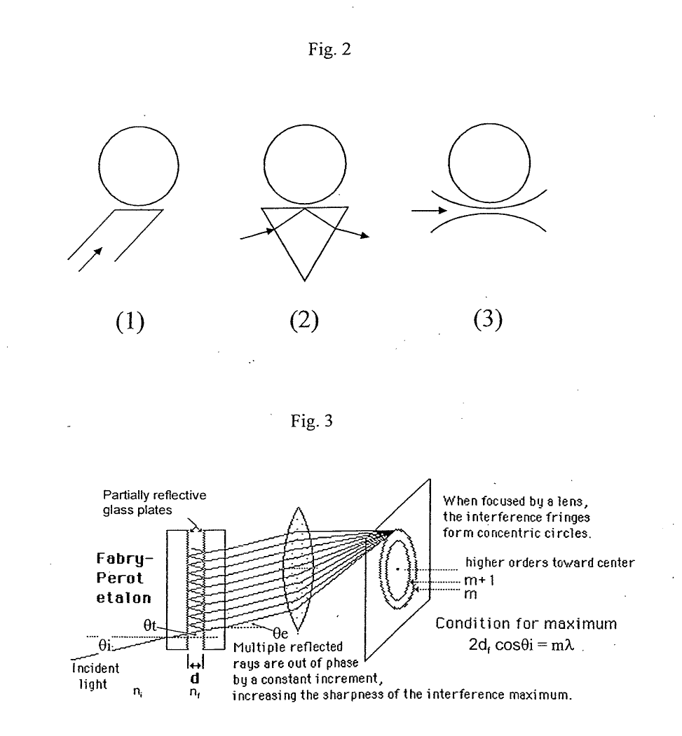

For this system, a simple and small detection system can be built according to one of the general schemes of FIG. 1. Which of the two is chosen depends on the size of the particle or cluster of particles and on its emission intensity. For particles with low emission power it might be useful to utilize the scheme shown in FIG. 1(I) that applies a collection optics 2 for collection of the fluorescence emission of the cavity 1, thus yielding higher photon flux. Typically, however, such collection optics magnifies the image of the bead, potentially causing cross-talk on the detector 7. Therefore, a slit or aperture 3 (e.g. a spherical aperture) can be used to limit the image size. The latter is also influenced by the magnification M=f₂/f₁ of the lens systems 4 and 6. However, as already discussed in the Technical Problem, for construction of a compact system it is best to choose M=1, i.e. f₁=f₂. The focal length f₂ of lens system 4 will be determined by other factors that will be discussed below. Also, a magnification of the image is unwanted. Therefore, M=1 yields the shortest optical path of the interference spectrometer 8 possible and thus the most compact design. In case of small beads, such as in the present example, also the scheme shown in FIG. 1(II) can be applied. Then, the particle or clusters themselves play the role of the aperture 3. A 10 μm bead as in the present example just fits the pixel dimension of a typical CCD camera (for M=1). Clusters should consist of smaller particles to reach a total dimension of few tens of micrometers maximum. This second approach works well in all cases in which the emission power of the bead is sufficiently high to allow for omission of a high N.A. collection optics 3, thereby drastically reducing the N.A. of the detection system and thus the photon flux available for analysis.

For the layout of the FP interferometer utilized as interferometric element 5 of the interferometric spectrometer 8, it is important to note that according to the formulas given above, the FSR δλ_{FP} and the bandwidths of the FP fringes, Δλ_{FP}, can be chosen independently of each other. The FSR is a function of the optical distance d_{f} between the plates and the operating wavelength λ₀, while the bandwidth of the ideal FP interferometer is solely determined by the reflectance R of its constituting plates. For the present example, we choose the FSR to be twice that of the bandwidth of the cavity modes, i.e. δλ_{FP}=0.2 nm and the bandwidth of the FP fringes to Δλ_{FP}=0.07 nm. For an operating wavelength of λ₀=500 nm as in the literature example, this results in d_{f}=625 μm. Note that d_{f} is the product of geometrical length d and refractive index n_{f} between the plates. To tune the FP interferometer, it is therefore possible to change the medium between the plates, e.g. by pumping different liquids or gases through the gap. This is advantageous over changing d because of the much lower demands on mechanical precision.

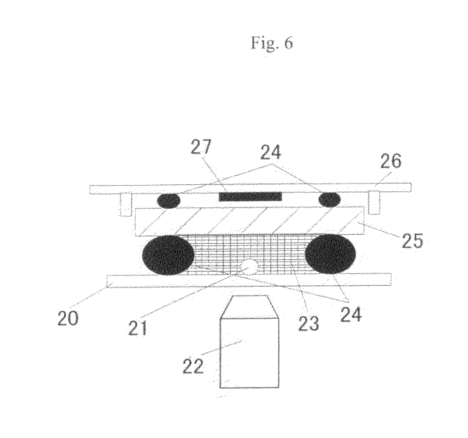

In result, the transmission maxima for the central fringe at θᵢ=θₜ=0 deg form a dense comb structure as a function of wavelength, as illustrated in FIG. 5. The bandwidths of the individual peaks may be much smaller or of same order as those of the cavity modes. Of course, excessive overlapping between neighboring peaks should be avoided, which restricts the bandwidth of the peaks to values smaller than the FSR. Most importantly, the resulting comb structure should exhibit a clear modulation between maxima and minima, which can be differentiated in the process of signal evaluation later on. To what extent the emission of a optical cavity mode is transmitted through this comb structure depends now on the relative position of the mode with respect to the comb. In the case of a change of the mode position, e.g. due to changes in the external parameters of the microcavity as they may be utilized in optical sensing, the mode moves across the comb structure, thereby causing a periodically changing intensity profile at the output side of the interferometer, i.e. on the photodetector 7. As illustrated in FIG. 5, the periodicity of the measured intensity profile reflects the spacing of the combs and allows a determination of the shift of the mode position, e.g. by simply counting the minima (for example, the DC offset of the signal can be filtered electronically). More sophisticated analysis might involve the determination of maxima and minima, and/or the turning points, thereby improving the lower detection limit for cavity mode shifts. Also, an analytical function may be fitted to the measured signal for the same purpose. Whether this signal can be properly detected or not depends on the distribution of the interference pattern on the photodetector 7. For example, in case of a CCD camera, the central maximum should fall onto one pixel, while the surrounding minimum should not. Given a pixel size of state-of-the-art CCD chips of 13.5 μm and taking into account that different signals should fall onto the after next pixel to become discernible without cross-talk, a minimum separation of 40.5 μm of central maximum and minimum is needed in the plane of the detector. Calculation of the exit angle θₑ^{min} for the given parameters according to equation 5 yields an angle of 1.146 deg, which finally gives a required focal length of lens system 4 of f₂=2.0 mm. The minimum length of the interference spectrometer 8 would then be 4×2.0 mm=8.0 mm (for M=1 as discussed above). Compared to the results of the dispersive spectrometer, which were calculated for the same parameters in the Technical Problem and resulted in an optical patch length of 2.2 m, this gives an amazing reduction in size of the detection system by a factor of 275. It should be noted that in this calculation it was assumed that the gap between the FP plates is filled with air, i.e. n_{f}=nᵢ=1. From equation 5 it follows that the angle θₑ^{min} can be further increased by choosing a high refractive material between the plates. The optical distance d_{f} could then be kept constant by changing the geometrical length d accordingly. Then, the size of the interferometric spectrometer 8 may even become smaller than 8 mm while keeping the same performance.

To achieve a bandwidth of the FP comb peaks of 0.1 nm or below, the reflectivity of the FP plates should be chosen 0.24 or better, which is a requirement easy to fulfill. For higher reflectivity R, i.e. in the case Δλ_{FP}<<Δλₘ, the periodic intensity pattern measured by the photodetector resembles the bandwidth of the cavity modes, which allows their precise determination and thus may be useful for precision mode analysis of optical cavity modes.

Notes:

(i) In this modus operandi it might be helpful to avoid a too large number of cavity modes to be analyzed simultaneously because of potential unwanted cross-talk, which might blur the periodic intensity modulation of the central fringe. A few or even a single mode can be selected for example by placing an optical bandpass filter between microcavity (1) and entrance of the interferometric spectrometer (8). Bandpass filters with few nanometers of spectral transmission, for example in the UV, visible, or IR regime, are commercially available. Typically, such filters are also based on interference effects and thus can be simply viewed at as part of the interferometric spectrometer (8).

(ii) The current example is taken from the literature and therefore not optimized with respect to the resolution of a sensing event. The resolution of the detection system is 0.1 nm given that minima and maxima in the periodic signal on the photodetector can be distinguished. This is about half the value of the expected shift for the adsorption of one bilayer of PE on the microcavity surface, i.e. it corresponds to about one monolayer PE. Given the simplicity of the device, this is already a satisfying result. To improve the sensitivity further, the Q-factor of the microcavities needs to be improved. This can be achieved by choosing other kinds of materials, e.g. titania for the cavity material instead of PS. Further details will be discussed in the materials section.

(iii) The system described above can be used as a simple “yes-no” sensor that reports about a successful sensing event. In such case, the photodetector can be a simple photodiode, equipped with an optional aperture that allows only the central fringe of the interference pattern to pass through. Such system would immediately digitize the sensor signal without any further AD conversion. With about 8 mm total length, the analysis system is so small that it can be implemented into any kind of hand-held or portable device, such as a digital camera, a cell phone, a remote control, a MP3 player, and even a wrist watch. In the case the portable device itself contains some light detection optics, e.g. as in case of a digital camera or a state-of-the-art mobile phone, such implementation may be utilized for the detection of the interferometer output and thus enhance the degree of integration. For example, the digital camera optics may play the role of lens systems 4 and/or 6 and its CCD chip that of the detector 7. Recalling that the present example has been found to have a sensitivity to molecular adsorption comparable to that of a surface plasmon resonance apparatus (A. Francois et al., Proc. SPIE, Vol. 6862, pp. 68211/1-8, 2008), this is a highly interesting perspective. Applications may be in areas of agriculture, such as for quick testing of raw milk or other agricultural products, food industry, environmental testing, civil security, and health care. In health care, for example, patients that require frequent monitoring of their body condition, such as needed for diabetes or in case of dialysis patients, would benefit from a portable, hand-held or even highly integrated monitoring and/or sensing device. The sensors could be of the “yes-no” type or—after optimization of their parameters, in particular the Q-factor of the microcavities—also be used for quantitative analysis.

(iv) The present example discusses the application of a FP interferometer with a FSR of the order of the microcavities to be analyzed to the analysis of low-Q PS beads with a nominal diameter of 10 μm. It must be noted that the results obtained here can be directly translated to other systems with higher or smaller Q-factor. The reason is that it has been found that both the wavelength shift due to molecular adsorption and the FSR of the systems scale with 1/R over a wide range of particle sizes, where R is the particle radius of a spherical cavity (S. Arnold et al., Optics Lett. Vol. 28, pp. 272-274, 2003; Weller et al., Appl. Phys. B, Vol. 90, pp. 561-567, 2008). Accordingly, the optical distance d_{f} of the FP interferometer can be adjusted such to fit the scale of the cavity mode spectra, leaving all fundamental aspects of detection and processing of the data unaltered. According to equation 5, only the separation angle θₑ^{min} might change, thus altering the total optical path of the interferometric spectrometer 8 to some extent. This, however, can be at least partially compensated by choosing a high-index material for the gap between the FP plates. To give some examples, reducing the FSR of the comb to δλ_{FP}=0.01 nm peak spacing results in an optical path length of the interferometric spectrometer 8 of 36.3 mm, while increasing it to δλ_{FP}=1 nm, gives a total path length of 3.63 mm. Further, for other kinds of microcavities with different shape or made from different materials, potentially other kinds of excitations schemes may have to be applied. This, however, does not affect the scheme used for their analysis. Such issues will be detailed in the materials section below.

(v) In the present example, the central fringe has been chosen for detection and analysis. While this may be advantageous because the central fringe exhibits the highest resolving power of the FP interferometer, it should be noted, that in principle any other interference order can be applied for same purpose. Then, potentially the size of the detector needs to be adjusted to the extension of the respective fringe pattern in the plane of detection 7.

4.2.2 Analysis of Cavity Modes by Means of an Interferometer with a FSR of the Order of the FSR of the Optical Cavity Modes to be Studied

In another basic example of interferometry applied to the analysis of optical cavity modes, e.g. in view of their spectral mode positions, i.e. energy levels, their bandwidths and/or their emission intensities, i.e. population, the FSR of the interferometer is chosen such that it is of the order of the FSR of the optical cavity modes to be analyzed. As in the first example of Section 4.2.1, we stick to 10 μm PS beads as example taken from the literature and apply again a FP interferometer as interferometric element 5. However, as already mentioned above, all other kinds of microcavities and interferometers matching some basic requirements, such as distinguishable cavity modes, i.e. δλₘ<δλₘ, and properly chosen FSR and peak bandwidth of the interferometer, can be applied for same purpose.

As detailed in Section 4.2.1, the two basic schemes of FIG. 1 can be applied for construction of the analytical system. For which one is better suited the same arguments hold as before. For the present example, i.e. a FSR of the cavity modes of 5 nm, the optical distance of the FP interferometer amounts to d_{f}=25 μm. Alternatively, if only a single mode is to be analyzed, the spectral separation of 2 nm within one doublet can be also considered, resulting in d_{f}=62.5 μm. This means that we are in the thin film regime of FP fabrication, which opens further opportunities since in addition to standard fabrication schemes, now also techniques of microfabrication, such as thin film deposition, lithography, and micro-/nanopatterning, may be applied by those skilled in the art to achieve interferometers with better performance than that of classical ones, e.g. with higher optical transmission and/or higher resolving power, and higher integration into the entire analytical system. Integration might be particularly valuable for connection of the interferometric spectrometer to an integrated optics device, such as a waveguide structure, coupling optics, and the like. The bandwidths of the FP maxima play a less important role in view of the large FSR. However, from the viewpoint of optimization of the analysis of the cavity modes, e.g. in view of their spectral positions and/or bandwidths, systems with high resolving power (Finesse), i.e. δλ_{FP}>>Δλ_{FP}, are preferably applied. The exit angle θₑ^{min} of the first minimum is now already quite large (5.73 deg for δλ_{FP}=5 nm, 3.62 deg for δλ_{FP}=2 nm), so that separation of the different interference orders even in a miniature device of some to some tens of millimeters is feasible. The main difference to the first example is the detection scheme to be applied. While in the first example upon spectral shifts in the cavity mode positions, a periodic pattern was traced, e.g. in the region of the central fringe, the intensity modulation is now much less pronounced and causes basically a movement of the different interference maxima, i.e. fringes, towards or from the central spot, depending on the direction of the spectral shift. Therefore, the optical resolution is now determined by the minimum discernible fringe movement. In one preferred embodiment, the fringe pattern is recorded by means of a CCD camera over a wide range of interference orders. Either the full 2D pattern can be recorded or one linear cross-section due to the spherical symmetry of the system. Also, it is possible to monitor only selected points of the image screen and to reconstruct the full pattern analytically. Due to the lower resolving power of these systems, the total size of the interferometric spectrometer 8 will become typically larger than those described in the previous section. Advantages will be, however, that by recording larger segments of the interference pattern, the absolute cavity mode positions can be determined even without occurrence of any spectral shift. Also, similar to holography, even complex interference patterns can be numerically processed, for example by means of Helmholtz-Kirchhoff theory. Accordingly, a larger number of cavity modes can be simultaneously traced, facilitating the precise determination of several parameters of the microcavity, such as its size and the refractive index of its environment. The approach applied here is therefore preferably suitable for benchtop applications.

4.2.3 Analysis of Cavity Modes by Means of Direct Superposition of the Optical Cavity Modes to be Studied

In a third basic scheme, wave interference can also be achieved without additional interferometric element 5 by direct interference of optical cavity modes. Here, for example the doublet emission as shown in FIG. 4, upper spectrum, can be utilized by selecting one specific doublet. The doublet modes refer to TE and TM modes of successive mode number and are known to shift to different extent upon changes in the external parameters of the microcavity (I. Teraoka and S. Arnold, J. Opt. Soc. Am. B, Vol. 24, pp. 653-659, 2007). Therefore, any change in the parameters governing the cavity modes will cause a change in the interference pattern of the superposed waves, which can be recorded e.g. by the photodetector 7 in the image plane of the interferometric spectrometer 8. For such purpose, the photodetector could be for example a spatially highly resolving CCD camera. It should be noted that for achievement of such direct interference, the polarization and/or direction of the propagation of the modes may have to be adjusted by measures described above.

This third scheme is related to holography, such as digital in-line holography using spherical wavelets, which has been recently re-discovered as effective means for high resolution imaging in the optical and X-ray regime without utilization of any optical elements (CA2376395, CA2450973). Similarly, and using the same or adapted numerical algorithms for reconstruction of the source (e.g. Helmholtz-Kirchhoff theory), cavity mode superposition on a digital imaging device may be a useful measure for fast, low cost, and miniature analysis of optical cavity modes. Also, some part of the interference patterns caused by direct interference of one or more cavity modes or even the emission of the microcavity, microcavities, or cluster(s) of microcavities in general may be exploited for holographic imaging as described in prior art (CA2376395, CA2450973), potentially simultaneously with optical sensing events. The applications of all these different schemes applying direct interference of optical cavity modes will be similar to those of Section 4.2.1, i.e. be located for example in areas of agriculture, food industry, environmental testing, civil security, and health care. Also, it will be possible to utilize the built-in CCD chip of certain hand-held devices, such as digital cameras and cell phones, for data collection and thus to further minimize the efforts of the analysis.

4.2.4 Other Means of Cavity Mode Analysis

Finally, it should be mentioned that the schemes described above in Sections 4.2.1-3 are basic schemes that can be adapted to the particular case under study, i.e. the kind of microcavity to be analyzed, its spectral operating range, and/or its environment. In particular, combinations of the different schemes are possible. For example, it may be wanted to select a certain number of cavity modes for processing. In such case either a suitable interference bandpass filter may be applied or for example, the kind of interferometer described in Section 4.2.2 can be utilized for such preselection. The transmitted cavity modes can then be further analyzed by means of the systems described in Sections 4.2.1-4.2.3.

Therefore, the embodiments are not limited to the present examples but have to be understood as tools that can be combined and utilized in different fashion by those skilled in the art.

4.3 Materials Section

In the following, the different materials that can be used for implementation of the schemes described above or combinations thereof, will be briefly described.

4.3.1 Microcavities

The microcavities and/or clusters of microcavities of the present embodiment can be manufactured by using materials, which are available to the public. The following explanations of the materials are provided to help those skilled in the art construct the microcavities in line with the description of the present specification.

Cavity Material:

Materials that can be chosen for fabrication of the cavity are those who exhibit low absorption in that part of the electromagnetic spectrum, in which the cavity shall be operated. For example, for fluorescence excitation of the cavity modes, this is a region of the emission spectrum of the fluorescent material chosen for operation of the cavity. Typical materials are polymer latexes, such as polystyrene, polymethylmethacrylate, polymelamine and the like, and inorganic materials, such different kinds of glasses, silica, titania, salts, semiconductors, and the like. Also core-shell structures and combinations of different materials, such as organic/inorganic or inorganic/organic, organic/organic, and inorganic/inorganic, are feasible. In the case of clusters of microcavities or that more than a single microcavity is used in an experiment, the different cavities involved (either constituting the cluster or those of the different single microcavities) may be made from different materials and also be optionally doped with different fluorescent materials, e.g. to allow their selective excitation. Also, the cavity (cavities) may consist of heterogeneous materials. In one embodiment, the cavity (cavities) is (are) made from semiconductor quantum well structures, such as InGaP/InGaAlP quantum well structures, which can be simultaneously used as cavity material and as fluorescent material, when pumped with suitable radiation. The typical high refractive index of semiconductor quantum well structures of about 3 and above further facilitates the miniaturization of the cavity or cavities because of the wavelength reduction inside of the semiconductor compared to the corresponding vacuum wavelength. In general, it is advantageous to choose a cavity material of high refractive index to facilitate miniaturization of the cavity or cavities.

It is also possible to choose a photonic crystal as cavity material and to coat either the outer surface of the crystal with a fluorescent material, or to embed the fluorescent material into the crystal in a homogeneous or heterogeneous fashion. A photonic crystal can restrict the number of excitable cavity modes, enforce the population in allowed modes, and define the polarization of the allowed modes. The kind of distribution of the fluorescent material throughout the photonic crystal can further help to excite only the wanted modes, while unwanted modes are suppressed due to improper optical pumping.

An example of photonic crystals comprising two or three-dimensional non-metallic periodic structures that do not allow the propagation of light within a certain frequency range, the so-called “bandgap” of the photonic crystal, was shown by E. Yablonovitch (Scientific American, December issue, pp. 47-55, 2001). The light is hindered from propagation by distributed Bragg diffraction at the periodic non-metallic structure, which causes destructive interference of the differently scattered photons. If the periodicity of such a photonic crystal is distorted by a point defect, e.g. one missing scattering center in the overall periodic structure, spatially confined allowed optical modes within the bandgap may occur, similar to those localized electronic energy levels occurring within the bandgap of doped semiconductors.

In the present invention, the optical cavities shown have a spherical shape. Although such spherical shape is a very useful one, the cavity may in principle have any shape, such as oblate spherical shape, cylindrical, or polygonal shape given that the cavity can support cavity modes, as shown in the prior art. The shape may also restrict the excitation of modes into a single or a countable number of planes within the cavity volume.

Fluorescent Material:

As fluorescent material, any type of material can be used that absorbs light at an excitation wavelength λ_{exc}, and re-emits light subsequently at an emission wavelength λₑₘ≠λ_{exc}. Thereby, at least one part of the emission wavelength range(s) should be located within the mode spectrum of the cavity for whose excitation the fluorescent material shall be used. In practice, fluorescent dyes, semiconductor quantum dots, semiconductor quantum well structures, carbon nanotubes (J. Crochet et al., Journal of the American Chemical Society, 129, pp. 8058-9, 2007), Raman emitters, and the like can be utilized. A Raman emitter is a material that uses the absorbed photon energy partially for excitation of internal vibrational modes and re-emits light with a wavelength higher than that of the exciting light. If a vibration is already excited, the emitted light may also have a smaller wavelength than the incoming excitation, thereby quenching the vibration (anti-Stokes emission). In any case, by proper choice of the excitation wavelength many non-metallic materials may show Raman emission, so that also the cavity materials as described above can be used for Raman emission without addition of a particular fluorescent material. Examples of the fluorescent dyes which can be used in the present embodiment are shown together with their respective peak emission wavelength (unit: nm): PTP (343), DMQ (360), butyl-PBD (363), RDC 360 (360), RDC 360-NEU (355), RDC 370 (370), RDC 376 (376), RDC 388 (388), RDC 389 (389), RDC 390 (390), QUI (390), BBD (378), PBBO (390), Stilbene 3 (428), Coumarin 2 (451), Coumarin 102 (480), RDC 480 (480/470), Coumarin 307 (500), Coumarin 334 (528), Coumarin 153 (544), RDC 550 (550), Rhodamine 6G (580), Rhodamine B (503/610), Rhodamine 101 (620), DCM (655/640), RDC 650 (665), Pyridin 1 (712/695), Pyridin 2 (740/720), Rhodamine 800 (810/798), and Styryl 9 (850/830). All these dyes can be excited in the UV (e.g. at 320 nm) and emit above 320 nm, e.g. around 450, e.g. in order to operate silver-coated microresonators (cf. e.g. WO 2007129682). For microresonators which are not coated with a silver shell, any other dye operating in the UV-NIR regime may be used. Examples of such fluorescent dyes are shown as follows: DMQ, QUI, TBS, DMT, p-Terphenyl, TMQ, BPBD-365, PBD, PPO, p-Quaterphenyl, Exalite 377E, Exalite 392E, Exalite 400E, Exalite 348, Exalite 351, Exalite 360, Exalite 376, Exalite 384, Exalite 389, Exalite 392A, Exalite 398, Exalite 404, Exalite 411, Exalite 416, Exalite 417, Exalite 428, BBO, LD 390, α-NPO, PBBO, DPS, POPOP, Bis-MSB, Stilbene 420, LD 423, LD 425, Carbostyryl 165, Coumarin 440, Coumarin 445, Coumarin 450, Coumarin 456, Coumarin 460, Coumarin 461, LD 466, LD 473, Coumarin 478, Coumarin 480, Coumarin 481, Coumarin 485, Coumarin 487, LD 489, Coumarin 490, LD 490, Coumarin 498, Coumarin 500, Coumarin 503, Coumarin 504 (Coumarin 314), Coumarin 504T (Coumarin 314T), Coumarin 510, Coumarin 515, Coumarin 519, Coumarin 521, Coumarin 521T, Coumarin 522B, Coumarin 523, Coumarin 525, Coumarin 535, Coumarin 540, Coumarin 540A, Coumarin 545, Pyrromethene 546, Pyrromethene 556, Pyrromethene 567, Pyrromethene 567A, Pyrromethene 580, Pyrromethene 597, Pyrromethene 597-8C9, Pyrromethene 605, Pyrromethene 650, Fluorescein 548, Disodium Fluorescein, Fluorol 555, Rhodamine 3B Perchlorate, Rhodamine 560 Chloride, Rhodamine 560 Perchlorate, Rhodamine 575, Rhodamine 19 Perchlorate, Rhodamine 590 Chloride, Rhodamine 590 Tetrafluoroborate, Rhodamine 590 Perchlorate, Rhodamine 610 Chloride, Rhodamine 610 Tetrafluoroborate, Rhodamine 610 Perchlorate, Kiton Red 620, Rhodamine 640 Perchlorate, Sulforhodamine 640, DODC Iodide, DCM, DCM Special, LD 688, LDS 698, LDS 720, LDS 722, LDS 730, LDS 750, LDS 751, LDS 759, LDS 765, LDS 798, LDS 821, LDS 867, Styryl 15, LDS 925, LDS 950, Phenoxazone 660, Cresyl Violet 670 Perchlorate, Nile Blue 690 Perchlorate, Nile red, LD 690 Perchlorate, LD 700 Perchlorate, Oxazine 720 Perchlorate, Oxazine 725 Perchlorate, HIDC Iodide, Oxazine 750 Perchlorate, LD 800, DOTC Iodide, DOTC Perchlorate, HITC Perchlorate, HITC Iodide, DTTC Iodide, IR-144, IR-125, IR-143, IR-140, IR-26, DNTPC Perchlorate, DNDTPC Perchlorate, DNXTPC Perchlorate, DMOTC, PTP, Butyl-PBD, Exalite 398, RDC 387, BiBuQ Stilbene 3, Coumarin 120, Coumarin 47, Coumarin 102, Coumarin 307, Coumarin 152, Coumarin 153, Fluorescein 27, Rhodamine 6G, Rhodamine B, Sulforhodamine B, DCM/Pyridine 1, RDC 650, Pyridine 1, Pyridine 2, Styryl 7, Styryl 8, Styryl 9, Alexa Fluor 350 Dye, Alexa Fluor 405 Dye, Alexa Fluor 430 Dye, Alexa Fluor 488 Dye, Alexa Fluor 500 and Alexa Fluor 514 Dyes, Alexa Fluor 532 Dye, Alexa Fluor 546 Dye, Alexa Fluor 555 Dye, Alexa Fluor 568 Dye, Alexa Fluor 594 Dye, Alexa Fluor 610 Dye, Alexa Fluor 633 Dye, Alexa Fluor 647 Dye, Alexa Fluor 660 Dye, Alexa Fluor 680 Dye, Alexa Fluor 700 Dye, and Alexa Fluor 750 Dye.

Combinations of different dyes may be used, for example with at least partially overlapping emission and excitation regimes, for example to tailor or shift the operation wavelength regime(s) of the microresonator(s).

Water-insoluble dyes, such as most laser dyes, are particularly useful for incorporation into the microcavities (e.g. in the case of polymer latex beads), while water-soluble dyes, such as the dyes obtainable from Invitrogen (Invitrogen Corp., Carlsbad, Calif.), are particularly useful for staining of the environment of the beads.

Semiconductor quantum dots that can be used as fluorescent materials for doping the microcavities have been described by Woggon and coworkers (M. V. Artemyev & U. Woggon, Applied Physics Letters 76, pp. 1353-1355, 2000; M. V. Artemyev et al., Nano Letters 1, pp. 309-314, 2001). Thereby, quantum dots (CdSe, CdSe/ZnS, CdS, CdTe for example) can be applied to the present embodiment in a similar manner as described by Kuwata-Gonokami and coworkers (M. Kuwata-Gonokami et al., Jpn. J. Appl. Phys. Vol. 31, pp. L99-L101, 1992), who have shown that the fluorescence emission of dye molecules can be utilized for population of microcavity cavity modes. The major advantage of quantum dots over dye molecules is their higher stability against degradation, such as bleaching. The same argument holds for semiconductor quantum well structures, e.g. made from InGaP/InGaAlP, which exhibit high stability against bleaching and cannot only be used as fluorescent material but also as cavity material.

The excitation wavelength λ_{exc} of the fluorescent material does not have necessarily to be smaller than its emission wavelength λₑₘ, i.e. λ_{exc}<λₑₘ, since one also can imagine multiphoton processes, where two or more photons of a given energy have to be absorbed by the material before a photon of twice or higher energy will be emitted. Also, as mentioned above, Raman anti-Stokes processes might be used for similar purpose.

Combinations of different fluorescent materials, such as those exemplified above, may be used, for example to tailor or shift the operation wavelength regime(s) of the optical cavity (cavities) or microresonator(s). This may be achieved, for example, by suitable combination of excitation and emission wavelength regimes of the different fluorescent materials applied.

In general, the fluorescent material can be incorporated into the cavity material or be adsorbed on its surface. The distribution can be used to select the type of cavity modes that are excited. For example, if the fluorescent material is concentrated in vicinity of the core surface, whispering gallery modes are more likely to be excited than Fabry-Perot modes. If the fluorescent material is concentrated in the center of the cavity, Fabry-Perot modes are easier to excite. Other examples of a heterogeneous distribution are those, in which the fluorescent material is distributed in an ordered fashion, i.e. in terms of regular two- or three-dimensional patterns of volumes with a high concentration of the fluorescent material. In such a case, diffraction effects may occur, which help to excite the cavity in distinct directions, polarizations, and/or modes, e.g., similar to those found in distributed feedback dye lasers.

Excitation Light Source:

The choice of light source for optical cavity mode excitation depends on the excitation scheme applied. For excitation via evanescent field coupling via an optical coupler or a focused light beam (see e.g. Oraevsky, Quant. Electron. Vol. 32, pp. 377-400, 2002), the emission wavelength range should match the wanted spectral regime of operation of the cavity. For excitation via fluorescence emission, the light source has to be chosen such that its emission falls into the excitation frequency range ω_{exc} of the fluorescent material. The emission power should be such that it can overcompensate the losses (radiation losses, damping, absorption, scattering) that may occur in the course of excitation of the microcavity or cluster of microcavities. In practice, thermal sources, such as tungsten or mercury lamps may be applied. Lasers or high power light emitting diodes with their narrower emission profiles will be preferably applied to minimize heating of sample and environment. If several fluorescent materials are utilized with properly chosen, e.g. non-overlapping, excitation frequency ranges, more than a single light source or a single light source with switchable emission wavelength range may be chosen such that individual microcavities or clusters of microcavities may be addressed selectively, e.g. to further facilitate the readout process or for the purpose of reference measurements. Further, a fluorescent microcavity may be operated above the threshold for stimulated emission of the cavity. In such case, the bandwidth of the operating cavity modes will further narrow, thus improving their quality factor (M. Kuwata-Gonokami et al., Jpn. J. Appl. Phys. (Part 2) Vol. 31, pp. L99ff.). This kind of operation will be particularly useful for the basic schemes of Sections 4.2.1-3.

Irrespective of the excitation scheme, preferred light sources are thermal sources, such as tungsten and mercury lamps, and non-thermal sources, such as gas lasers, solid-state lasers, laser diodes, DFB lasers, and light emitting diodes (LED). For excitation of (a) microresonator(s) or cluster(s) of microresonators, a LED can be preferably chosen such that its emission falls at least partially into the excitation frequency range ω_{exc} of (at least one of) the fluorescent material(s) applied. The emission power should be such that it can overcompensate the losses (radiation losses, damping, absorption, scattering) that may occur in the course of excitation of the microresonators. If several fluorescent materials are utilized with suitably chosen, e.g. non-overlapping or partially overlapping, excitation frequency ranges, more than a single LED may be chosen such that individual microresonators or clusters of microresonators may be addressed selectively, e.g. to further facilitate the readout process or for the purpose of reference measurements. For example, it may be desirable to address only a single microresonator within a cluster. Further, the excitation power of at least one of the LEDs may be chosen such that at least one of the microresonator(s) or cluster(s) of microresonators utilized is/are operated—at least temporally—above the lasing threshold of at least one of the optical cavity modes excited.

Shell:

The cavities and/or the clusters of microcavities may be embedded in a shell which might have a homogeneous thickness or not. The shell may consist of any material (metal, dielectric, semiconductor) that shows sufficient transmission at the excitation wavelength λ_{exc} of the chosen fluorescent material in the case of fluorescence emission or of the operating wavelength λₘ in the case of evanescent field coupling. Also, the shell may consist of different materials with wanted properties, for example to render the surface of microresonator(s) and/or cluster(s) of microresonators transparent only at wanted locations and/or areas or—to give another example—to facilitate selective (bio-)functionalization.

For example, when applying semiconductors as shell materials, the shell becomes transparent when the excitation wavelength is higher than the wavelength corresponding to the bandgap of the considered semiconductor. For a metal, high transparency may be achieved, for example, by taking advantage of the plasma frequency of the metal, above which the conduction electrons of the metal typically do no longer contribute to the absorption of electromagnetic radiation. Among useful metals are aluminum and transition metals, such as silver, gold, titanium, chromium, cobalt and the like. The shell can be continuous, as fabricated for example via evaporation or sputtering, or contiguous as often achieved by means of colloidal metal particle deposition and subsequent electroless plating (Braun & Natan, Langmuir 14, pp. 726-728, 1998; Ji et al., Advanced Materials 13, pp. 1253-1256, 2001; Kaltenpoth et al., Advanced Materials 15, pp. 1113-1118, 2003). Also, the thickness of the shell may vary from few nanometers to several hundreds of nanometers. The only stringent requirement is that the reflectivity of the shell is sufficiently high in the wanted spectral range to allow for Q-factors with values of Q>1. For FPM in spherical cavities, the Q-factor can be calculated from the reflectance of the shell 4 (or vice versa) by the formula

$$Q = \frac{{λ}_{m}}{{Δλ}_{m}} = m π \frac{\sqrt{{R}_{sh}}}{1 - {R}_{sh}} \qquad ( 6 )$$

where Rₛₕ is the reflectance of the shell and □ₘ the wavelength of cavity mode m.

Biofunctional Coating:

The microcavity (microcavities) or clusters of microcavities may be coated with a (bio-) functional coating facilitating their (bio-)mechanical and/or (bio-) chemical function. For example, they may be functionalized with specific analytes to initiate a wanted cell response, or to facilitate biomechanical and/or biochemical sensing. For sake of brevity, the microresonators or clusters of microresonators will be called “the sensor” in the following.

To render the sensor selective for specific analytes, it is preferred to coat the sensor surface with coupling agents that are capable of (preferably reversibly) binding an analyte, such as proteins, peptides, and nucleic acids. Methods for conjugating coupling agents are well-known to those skilled in the art for various kinds of surfaces, such as polymers, inorganic materials (e.g. silica, glass, titania) and metal surfaces, and are equally suitable for derivatizing the sensor surface of the present embodiments. For example, in the case of a transition metal-coating (e.g. gold, silver, copper, and/or an alloy and/or composition thereof), the sensor of the present embodiments can be chemically modified by using thiol chemistries. For example, the metal-coated non-metallic cores can be suspended in a solution of thiol molecules having an amino group such as aminoethanethiol so as to modify the sensor surface with an amino group. Next, biotin modified with N-hydroxysuccinimide suspended in a buffer solution of pH 7-9 can be activated by EDC, and added to the sensor suspension previously modified by an amino group. As a result, an amide bond is formed so as to modify the metal-coated non-metallic cores with biotin. Next, avidin or streptavidin comprising four binding sites can be bound to the biotin. Next, any biotin-derivatized biological molecule such as protein, peptide, DNA or any other ligand can be bound to the surface of the avidin-modified metal-coated non-metallic cores.

Alternatively, amino-terminated surfaces may be reacted with an aqueous glutardialdehyde solution. After washing the sensor suspension with water, it is exposed to an aqueous solution of proteins or peptides, facilitating covalent coupling of the biomolecules via their amino groups (R. Dahint et al., Anal. Chem., 1994, 66, 2888-2892). If the sensor is first carboxy-terminated, e.g. by exposure to an ethanolic solution of mercaptoundecanoic acid, the terminal functional groups can be activated with an aqueous solution of EDC and N-hydroxysuccinimide. Finally, proteins or peptides are covalently linked to the activated surface via their amino groups from aqueous solution (Herrwerth et al., Langmuir 2003, 19, 1880-1887).

In a similar fashion, also non-metallic sensors can be specifically functionalized. For example, polyelectrolytes (PE), such as PSS, PAA, and PAH, can be used as described in the literature (G. Decher, Science Vol. 277, pp. 1232ff., 1997; M. Lösche et al., Macromol. Vol. 31, pp. 8893ff., 1998) to achieve a sensor surface comprising a high density of chemical functionalities, such as amino (PAH) or carboxylic (PAA) groups (this technique is also applicable to metal-coated sensors). Then, for example the same coupling chemistries as described above can be applied to these PE coated sensors. Alternatively, and in analogy to the thiol chemistry described above for functionalization of metal surfaces, suitable kinds of coupling agents, such as amino-, mercapto-, hydroxy-, or carboxy-terminated siloxanes, phosphates, amines, carboxylic or hydroxamic acids, and the like, can be utilized for chemical functionalization of the sensor surface, on which basis then coupling of biomolecules can be achieved as described in the examples above. Suitable surface chemistries can be found in the literature (e.g. A. Ulman, Chem. Rev. Vol. 96, pp. 1533-1554, 1996).

A general problem in controlling and identifying biospecific interactions at surfaces and particles is non-specific adsorption. Common techniques to overcome this obstacle are based on exposing the functionalized surfaces to other, strongly adhering biomolecules in order to block non-specific adsorption sites (e.g. to BSA). However, the efficiency of this approach depends on the biological system under study and exchange processes may occur between dissolved and surface bound species. Moreover, the removal of non-specifically adsorbed biomolecules may require copious washing steps, thus, preventing the identification of specific binding events with low affinity.

A solution to this problem is the integration of the coupling agents into inert materials, such as coatings of poly-(PEG) and oligo(ethylene glycol) (OEG). The most common technique to integrate biospecific recognition elements into OEG-terminated coatings is based on co-adsorption from binary solutions, composed of protein resistant EG molecules and a second, functionalized molecular species suitable for coupling agent coupling (or containing the coupling agent itself). Alternatively, also direct coupling of coupling agent to surface-grafted end-functionalized PEG molecules has been reported.

Recently, a COOH-functionalized poly(ethylene glycol) alkanethiol has been synthesized, which forms densely-packed monolayers on gold surfaces. After covalent coupling of biospecific receptors, the coatings effectively suppress non-specific interactions while exhibiting high specific recognition (Herrwerth et al., Langmuir 2003, 19, pp. 1880-1887).

The binding entities immobilized at the surface may be proteins such as antibodies, (oligo-)peptides, oligonucleotides and/or DNA segments (which hybridize to a specific target oligonucleotide or DNA, e.g. a specific sequence range of a gene, which may contain a single nucleotide polymorphism (SNP), or carbohydrates). To reduce non-specific interactions, the binding entities will preferably be integrated in inert matrix materials.

Position Control Functionality:

The sensors of the present embodiments may be utilized as remote sensors and therefore may require control of their positions and/or movements by external means, for example to control their contact and/or interaction with a selected cell. Such control may be achieved by different means. For instance, the sensors may be rendered magnetic and electromagnetic forces may be applied to direct the sensor(s) (C. Liu et al., Appl. Phys. Lett. Vol. 90, pp. 184109/1-3, 2007). For example, paramagnetic and super-paramagnetic polymer latex particles containing magnetic materials, such as iron compounds, are commercially available from different sources (e.g. DynaBeads, Invitrogen Corp., or BioMag/ProMag microspheres, Polysciences, Warrington, Pa.). Because the magnetic material is embedded into a polymeric matrix material, which is typically made of polystyrene, such particles may be utilized in the same or a similar way as optical cavity mode sensors as the non-magnetic PS beads described in the examples below. Alternatively or in addition, a magnetic material/functionality may be borne by the shell of the microresonator(s) and/or their (bio-)functional coating.

Further, the position control may be mediated by means of optical tweezers (J. R. Moffitt et al., Annu. Rev. Biochem. Vol. 77, pp. 205-228, 2008). In such case, the laser wavelength(s) of the optical tweezers may be either chosen such that it does or that it does not coincide with excitation and/or emission wavelength range(s) of the fluorescent material(s) used to operate the sensor. For example, it might be desirable to use the optical tweezers' operating wavelength also for (selective) excitation of (one of) the fluorescent material(s). One advantage of optical tweezers over magnetic tweezers would be that a number of different sensors may be controlled individually at the same time (C. Mio et al., Rev. Sci. Instr. Vol. 71, pp. 2196-2200, 2000).

In other schemes, position and/or motion of the sensors may be controlled by acoustic waves (M. K. Tan et al., Lab Chip Vol. 7, pp. 618-625, 2007), (di)electrophoresis (S. S. Dukhin and B. V. Derjaguin, “Electrokinetic Phenomena”, John Wiley & Sons, New York, 1974; H. Morgan and N. Green, “AC Electrokinetics: colloids and nanoparticles”, Research Studies Press, Baldock, 2003; H. A. Pohl, J. Appl. Phys. Vol. 22, pp. 869-671, 1951), electrowetting (Y. Zhao and S. Cho, Lab Chip Vol. 6, pp. 137-144, 2006), and/or by a microfluidics device that potentially may also be capable of sorting/picking particles and/or cells of desired dimension and/or function (S. Hardt, F. Schönfeld, eds., “Microfluidic Technologies for Miniaturized Analysis Systems”, Springer, New York, 2007).

Also mechanical tweezers may be utilized for position control of the sensor(s), for example by employing a microcapillary capable of fixing and releasing a particle via application of pressure differences (M. Herant et al., J. Cell Sci. Vol. 118, pp. 1789-1797, 2005). The beauty of this approach is that for example in cell sensing experiments, sensors and cells may be manipulated using the same instrumentation (cf. M. Herant et al.). Also combinations of two or more of the schemes described above may be suitable for position control of sensor(s) and/or cell(s).

4.3.2 Interferometric Spectrometer

Collection Optics 2:

For collection of the emission of the microcavity or microcavities, any kind of state-of-the-art optics can be applied. Preferably, the collection optics has a high N.A. on its entrance side to optimize the collected light power and potentially a low N.A. on its output side to match the requirements of the subsequent imaging onto the photodetector 7. Preferably, microscope objectives can be applied as well as any kind of microscope system with sufficient optical resolution, i.e. sufficiently large N.A. Also, in particular for utilization in highly integrated devices, the collection optics may utilize (additionally or alternatively) an integrated optics system, a waveguide, an optical fiber, and/or an optical near-field probe. In such case, the optical coupling between collection optics and the microcavity or microcavities may be mediated by optical near-field coupling and/or evanescent field coupling. Also, a sufficiently large N.A. may be achieved by the close geometrical vicinity achievable between the microcavity or microcavities and the collection optics, which otherwise may be more difficult to achieve and control.

Interferometric Element 5:

As discussed already above, any kind of interferometric principle that matches the requirements of the set-up according to Sections 4.2.1-3 can be applied. In preferred embodiments, such interferometric principles are based on Fabry-Perot-, Fizeau-, Jamin-, Kösters-, Lummer-Gehrke-, Mach-Zehnder-, Michelson-Interferometers and the like. In particular thin film or thin plate interferometers are useful because of their small dimension. Also, multiple beam interferometers may be preferred over dual beam interferometers due to their higher resolving power. Among the thin film interferometers and/or FP interferometers, those with high transmittance may be preferably applied, in particular for microcavities with low emission power and those set-ups based on the scheme shown in FIG. 1(II). Thus, dielectric interferometers may be preferred over those applying metallic reflectors due to their lower reflection losses. Most interferometric elements, such as FP interferometers, are commercially available with different finesse and for different spectral ranges of operation from the UV to the mid IR.

Photodetector 7:

Depending on the detection scheme (see Sections 4.2.1-3), different kinds of detectors can be applied, either spatially non-resolving ones, such as photomultipliers, photoelements, and photodiodes, and spatially resolving ones, such as CCD chips and photodiode arrays. For a simple “yes-no” sensor as described in Section 4.2.1, a simple photodiode may be preferably used. For imaging of larger areas of the fringe pattern and in particular for the free-wave interference as discussed in Section 4.2.3, a high resolution CCD camera or CCD chip may be the preferred choice.

Resolving Power of Interferometer:

The interferometer with high resolving power of finesse F>20 can be utilized in the analyzing system. Further, the interferometer with low resolving power of finesse F<20 can be also utilized in the analyzing system.

Geometrical Length of its Optical Detection Path:

The interferometer may have any geometrical length of its optical detection path, including the path of 25 cm or below, the path of 10 cm or below, the path of 4 cm or below, or the path of 1 cm or below.

5. Examples of Utilization of the Invention

The present invention proves useful and advantageous over existing technology in all cases that require precise characterization of cavity modes, for example in terms of their positions (energy levels), bandwidths, and/or intensities (population), or minute changes thereof, while keeping the experimental efforts in terms of equipment applied and geometrical size of the set-up small. Because of these prospects, interference spectroscopy will contribute to a significant evolution of the utilization of microcavities in different size regimes and for a variety of applications, such as the development of precision microlasers, optical filters, and optical sensors.

With regard to optical sensing, optical biosensing, robust and easy-to-use portable or hand-held systems of high sensitivity, as they are needed for fast testing and screening in agriculture, food industry, environmental testing, civil security, and health care, will be drastically facilitated. In agriculture, field instruments capable of quick testing right on the spot will be useful, e.g. for raw milk control and other quality and health related issues. Food industry has similar demands for quality control and monitoring during food processing. For environmental testing, miniature hand-held and optionally solar cell driven water monitors and testers may become an essential tool particularly in those areas in which clean water is more and more difficult to find. Civil security also relies strongly on fast and reliable quick testing right on the spot, in particular in view of fast spreading viral or bacterial diseases. In health care, the increasing need for cost reduction drives the demand on point-of-care testing and self tests, which require simple, hand-held label-free biosensors that should be also capable of detection of a number of different analytes simultaneously (multiplexing). Other examples of potential applications are related to drug screening, biomolecular screening, protein screening, nucleotide screening, proteomics and genomics, and health care industry. In particular for the latter applications, screening in any array formats for parallel detection of a large number of analytes is of high interest. This can be facilitated by the present embodiments due to the drastic reduction in the instrument's size, the simplicity of its set-up as well as the speed of processing. Thereby, multiplexing may be performed by tracing different interference patterns—on the same or different photodetectors 7—simultaneously or, alternatively, by scanning of the sample 1 in the object plane. Further, the analysis system can be utilized for various testing purposes in various fields including: on-the-spot testing in agriculture or food industry, on-the-spot testing of raw milk or meat, quick testing in veterinary medicine, quick testing in health care or medical diagnostics, point-of-care testing of diabetes or dialysis patients, quick testing in civil security, quick testing of viral infections, quick testing of hepatitis B, quick testing of influenza, quick testing of the human immunodeficiency virus (HIV), quick testing of bovine spongiform encephalopathy (BSE), quick testing of bacteria, quick testing of legionella, quick testing of lyme-disease, quick testing in environmental analysis, and/or quick testing of water samples.

Due to the small dimensions of the interferometric spectrometer 8 achievable, small, sensitive, label-free optical sensors can be obtained. With about 8 mm total length as calculated for the example of Section 4.2.1, the analysis system is so small that the entire system or any part of the system can be implemented into any kind of hand-held or portable device, such as a digital camera, a cell phone, a remote control, an MP3 player, a wrist watch, and part of these devices for detection of the optical interferometer output. In the case that the portable device itself contains some light detection optics, e.g. as in case of a digital camera or a state-of-the-art cell phone, such implementation may be utilized for the detection of the interferometer output and thus enhance the degree of integration.

In a different embodiment, the microcavity including its interferometric analyzer may be fully integrated into an integrated optics device, a waveguide structure, photonic crystal, or any kind of suitable optoelectronic device. This can be wanted, for example, for the fabrication of miniature high-precision light sources as they are needed for optically driven information bus systems or quantum processing.

Also, combinations with holographic elements, in particular with the basic scheme introduced in Section 4.2.3, may combine spectral analysis with (holographic) imaging. For example, the interference pattern formed by direct interference of optical cavity modes may be exploited to give the result of a (bio-)sensing event. At the same time some part of the interference pattern of the emission of the microcavity (microcavities) or cluster of microcavities (cf. working example) may be exploited by the technique of digital in-line holography for calculation of an holographic image (3D image) of the environment during the sensing event. Such art may become very valuable in particular in connection with fluorescent microcavities of small dimension (few micrometers and below) because of their capability of remote sensing, which paves the way for in-situ sensing, e.g. in microfluidics, and possibly even for in-vitro or in-vivo applications, such as sensing and imaging in live cells (cf., eg., U.S. provisional application No. 61/111,369).

Working Example

Recording of Interference Patterns Induced by the Fluorescence Emission of Dye-Doped Polystyrene Microcavities

As a first demonstration of the feasibility of visualization and recording of the direct interference of the radiative emission of a microcavity without use of any additional interferometric element 5 as detailed in Sect. 4.2.3, the following experiment was performed.

As shown in FIG. 6, an optical microcavity 21, e.g. a fluorescently doped polystyrene microbead, is placed onto a suitable substrate 20. The microcavity is confined by placing an O-ring 24, e.g. made from viton, onto the surface 20 and by subsequent attachment of an optical color filter 25 from the top. The closed volume 23 confined by substrate 20, O-ring 24 and color filter 25, can be filled with a fluid, e.g. with water or buffer solution, before closing. On top of the color filter, the circuit board 26 of a simple CCD camera, such as a commercially available webcam, can be placed, e.g. by using a second O-ring 24 as soft and electrically isolating spacer. The circuit board, which bears the CCD chip of the camera without further optical element for beam diffraction, such as a focusing lens, should be positioned in such way that the CCD chip is centered above the microcavity in vertical direction. The entire system can be clamped together, e.g. by two suitable plates and a couple of suitable screws (not shown). It should be noted that the color filter has the shape of a flat plate with parallel surfaces, which do not diffract transmitting radiation, and was chosen such that it suppresses the laser radiation used for excitation of the fluorescent dye by an attenuation factor of ˜3.75×10⁻⁵, while the fluorescence emission can transmit the filter at a transmission of >75% across the relevant range (580-650 nm). Further, the substrate used for bearing the microbead was sputter-coated with a thin film of Pt (about 15-20 nm thickness) to support reflection of the fluorescence emission from the microbead into the direction of the CCD chip and thus to increase total intensity.

From the bottom side, the microbead can be microscopically observed and optically pumped by means of a microscope objective 22. The latter can also be used for collection of light emitted from the microcavity. This can be achieved, e.g., by mounting the microscope objective to an inverted microscope (e.g. Nikon TS100) and utilization of the camera port of that microscope for the connection to a spectral analysis system. Examples of such art for excitation and detection of optical cavity modes can be found in the prior art (cf., e.g., Francois & Himmelhaus, Appl. Phys. Lett. 94 (2009) 031101 and supplemental material of that article E-APPLAB-94-019901).

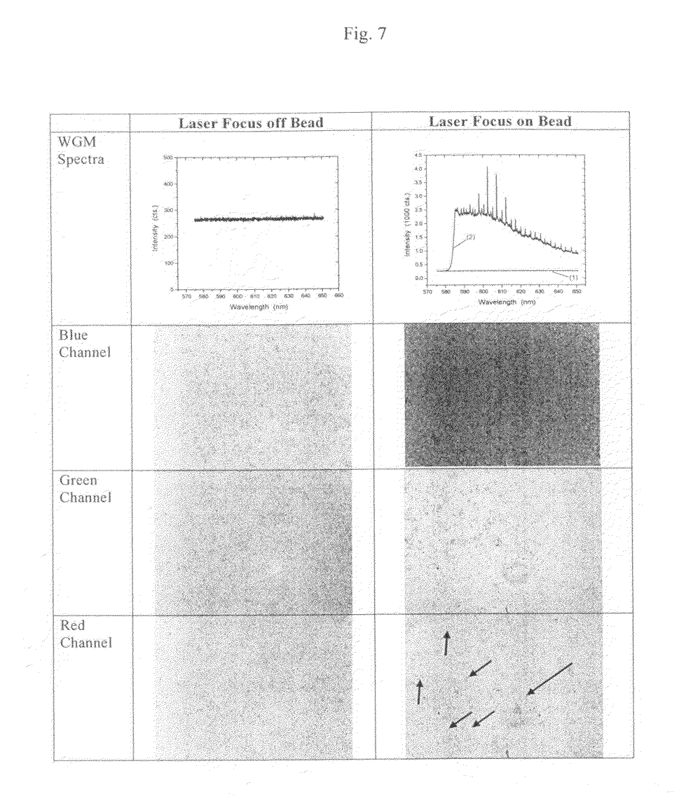

In the present example, as microcavity, a Nile Red-doped polystyrene bead with a nominal diameter of 15 mm was applied. The dye was excited by means of frequency-doubled Nd:YAG laser operated at a repetition rate of 10 kHz and an average power of about 50 mJ at the exit of the microscope objective. Spectral analysis of the light sampled from the microbead upon fluorescence excitation was achieved by means of a high resolution monochromator equipped with a cooled CCD camera. For the spectra shown in FIG. 7, the exposure settings of the camera were 0.2 s single acquisition. For further details of the system utilized for spectral analysis of the bead's fluorescence emission, we refer to the literature (Francois & Himmelhaus, Appl. Phys. Lett. 94 (2009) 031101 and supplemental material E-APPLAB-94-019901).

The CCD chip utilized in this experiment was obtained from dismantling a Buffalo USB webcam, model no. BSW3K03HSV (Buffalo Kokuyo Supply Inc., Japan). The focusing lens was removed and the black plastic shielding for light protection surrounding the CCD chip on the circuit board was widened to allow mounting of the color filter 25 and free optical access to the CCD chip. For operation of the chip, a freeware software (webcamXP Free, v5.3.4.252, www.webcamXP.com), which allows single shot, picture series, and video acquisition, was applied. The images shown in the following were taken in single shot mode after proper positioning and alignment of the excitation laser focus.

FIG. 7 displays spectra and images obtained from a single Nile Red-doped microbead with the focus of the excitation laser either off or on the bead, respectively. This was achieved by first optimizing the fluorescence emission obtained from the bead by using the xyz-translation of the inverted microscope (“laser focus on bead”) and then, after acquisition of the respective spectrum and CCD chip image, moving the stage in xy direction until the fluorescence emission had dropped (“laser focus off bead”). Then, a second data set was acquired.

The corresponding fluorescence emission can be seen in the spectra shown in the first row of FIG. 7. While in the “off” case, no fluorescence could be detected, because the laser did not hit the microbead, the “on” case shows a WGM spectrum characteristic for microcavity operation in the stimulated emission regime, i.e. under lasing condition. This can be seen from the Gaussian-shaped intensity distribution of the observed cavity modes (see, for example, Francois & Himmelhaus, Appl. Phys. Lett. 94 (2009) 031101). We chose lasing condition because of the stronger intensity and higher spatial and temporal coherence of the modes, which helps the observation of interference effects. This does not mean, however, that interference cannot be achieved when operating the microcavity below lasing threshold rather than that in such case proper conditions for their occurrence have to be met. Therefore, the approach chosen here must be considered as an example only.

One specialty of the CCD chip used is that it is a color chip, i.e. it produces color images of the light illuminating the chip area. This is an interesting feature because it allows a rough classification of the detected radiation into different wavelength regimes (blue, green, red). We achieved this classification, which is shown in FIG. 7, by splitting the color images into the corresponding color channels using commercial software (Corel Photo-Paint 12). Since the fluorescence emission is located only in the green/red part of the optical spectrum, the blue channel can be used as a reference channel, thereby ruling out any influence of scattering of the excitation laser or cross-talk between color channels or other sources for misinterpretation of the results.

The excitation laser is located in the green part of the optical spectrum and therefore can be observed in the “off” condition as mild spot in the green channel. The low intensity of the spot validates the choice of the color filter used for its suppression. In the images of the blue and red channels, the laser spot only very vaguely discernible. This indicates that the picosecond radiation impinging onto the color filter does not cause unwanted autofluoresence during the absorption process and also that cross-talk between the different color channels is negligible.

When the laser focus is placed onto the bead to stimulate its fluorescence excitation, the blue channel remains dark and homogeneous. Green and red channels, however, now show a number of circular interference patterns. It should be noted that although the on-board electronics of the CCD chip always tries to balance contrast and brightness of the images, the chip always got blinded for a few seconds upon onset of the bead's fluorescence until the control electronics could counterbalance the strong increase in photon flux onto the chip. Therefore, the dark appearance of the blue channel in the “on” case is only a relative measure with respect to the green and red channels rather than on an absolute scale.

The black arrows in the image of the red channel indicate some of the most important interference features. While the long arrow points to the position of the microbead and thus marks the interference of its fluorescence emission in its immediate vicinity, other interference patterns are caused by scattering of the fluorescence emission at obstacles on the surface, such as other microbeads or surface contamination. We could conclude this from moving the laser focus to other parts of the surface, which then showed that mostly microbeads were present at those locations as could be concluded from their fluorescence emission.

While the present experiment is a simple example that may be surely improved in many technical aspects, it demonstrates that the optical cavity mode emission of microcavities can be brought to interference even in the far-field and that the corresponding interference patterns can be recorded by means of a rather simple recording device. Most importantly, the interference was achieved without use of any optical elements, just by direct emission of the fluorescence and/or its reflection from the surface and/or obstacles thereon.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A system for analyzing an optical cavity mode of at least one microcavity or at least one cluster of microcavities, comprising:
an apparatus for sensing a change in the condition of or for analyzing one or more optical cavity modes by utilizing an optical interference thereof.

2. The system according to claim 1, wherein: the apparatus is an interferometer.

3. The system according to claim 1, wherein: the apparatus is a multiple beam interferometer.

4. The system according to claim 1, wherein: the apparatus is a Fabry-Perot interferometer.

5. The system according to claim 2, wherein:
the interferometer is an interferometer with a free spectral range of the order of the bandwidth of the optical cavity modes to be analyzed.

6. The system according to claim 2, wherein:
the interferometer is an interferometer with a free spectral range of the order of the free spectral range of the optical cavity modes to be analyzed.

7. The system according to claim 2, wherein:
the interferometer is an interferometer with a free spectral range of the order of a cavity mode shift to be analyzed induced by a change of a parameter of the microcavity or the cluster of microcavities.

8. The system according to claim 1, wherein:
the apparatus utilizes one or more interference patterns of the direct interference of one or more optical cavity modes to be analyzed.

9. The system according to claim 1, wherein:
the entire system or a part of the system is integrated into a hand-held device.

10. The system according to claim 1, wherein:
the entire system or a part of the system is integrated into a cell phone.

11. The system according to claim 2, wherein:
the interferometer is an optical interferometer having an output, and
the entire system or a part of the system utilizes a digital camera or part of it for detection of the optical interferometer output.

12. The system according to claim 2, wherein:
the interferometer is an optical interferometer having an output, and
the entire system or a part of the system utilizes a digital camera of a cell phone or part of it for detection of the optical interferometer output.

13. The system according to claim 1, wherein:
the system is utilized for sensing in an array format.

14. A method for analyzing an optical cavity mode of at least one microcavity or at least one cluster of microcavities, comprising the steps of:
sensing a change in the condition of or analyzing one or more optical cavity modes by utilizing an optical interference thereof.
